(19) United States
(12) Patent Application Publication
(10) Pub. No.: US 2022/0303949 A1
(43) Pub. Date: Sep. 22, 2022

(54) SLOT AND SUBSLOT-BASED SIDELINK COMMUNICATION

(71) Applicant: QUALCOMM Incorporated, San Diego, CA (US)

(72) Inventors: Seyedkianoush Hosseini, San Diego, CA (US); Wei Yang, San Diego, CA (US)

(21) Appl. No.: 17/206,333

(22) Filed: Mar. 19, 2021

(51) Int. Cl. H04W 72/02; H04W 72/04; H04W 24/08; H04W 28/26

(52) U.S. Cl. CPC H04W 72/02; H04W 72/0446; H04W 72/0466; H04W 24/08; H04W 28/26

(57) ABSTRACT

Methods, systems, and devices for wireless communications are described. In a wireless communications system, a first UE may determine, for a set of symbols for sidelink communications between the first UE and a second UE, a first resource configuration including a single first TTI and a second resource configuration including two or more second TTIs. The first TTI and the second TTIs may span the set of symbols, and the two or more second TTIs may be shorter in length than the single first TTI. The first UE may select, from the first resource configuration and the second resource configuration, a sidelink channel resource configuration for a data transmission to the second UE. Then, the first UE may transmit the data transmission to the second UE according to the selected sidelink channel resource configuration.

### INTRODUCTION

The following relates to wireless communications, including managing sidelink communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communication at a first UE is described. The method may include determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The method may further include selecting, from the first resource configuration and the second resource configuration, a sidelink channel resource configuration for a data transmission to the second UE, and transmitting the data transmission to the second UE according to the selected sidelink channel resource configuration.

An apparatus for wireless communication at a first UE is described. The apparatus may include a processor and memory coupled with the processor. The processor and the memory may be configured to determine, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The processor and the memory may be configured to select, from the first resource configuration and the second resource configuration, a sidelink channel resource configuration for a data transmission to the second UE, and transmit the data transmission to the second UE according to the selected sidelink channel resource configuration.

Another apparatus for wireless communication at a first UE is described. The apparatus may include means for determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The apparatus may further include means for selecting, from the first resource configuration and the second resource configuration, a sidelink channel resource configuration for a data transmission to the second UE, and means for transmitting the data transmission to the second UE according to the selected sidelink channel resource configuration.

A non-transitory computer-readable medium storing code for wireless communication at a first UE is described. The code may include instructions executable by a processor to determine, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The code may further include instructions executable by the processor to select, from the first resource configuration and the second resource configuration, a sidelink channel resource configuration for a data transmission to the second UE, and transmit the data transmission to the second UE according to the selected sidelink channel resource configuration.

Some examples of the method, apparatuses, and non-transitory computer-readable medium described herein may further include operations, features, means, or instructions for monitoring, during a first symbol of the set of symbols, for a reservation signal received from a third UE for one or more symbols within the set of symbols, where selecting the sidelink channel resource configuration may be based on the monitoring.

Some examples of the method, apparatuses, and non-transitory computer-readable medium described herein may further include operations, features, means, or instructions for detecting the reservation signal from the third UE during the first symbol of the set of symbols, the reservation signal indicating a second data transmission within a second symbol of the set of symbols transmitted from the third UE to the second UE according to the first resource configuration, where selecting the sidelink channel resource configuration includes selecting the first resource configuration based on detecting the reservation signal from the third UE.

Some examples of the method, apparatuses, and non-transitory computer-readable medium described herein may further include operations, features, means, or instructions for failing to detect the reservation signal from the third UE during the first symbol of the set of symbols based on the monitoring, where selecting the sidelink channel resource configuration includes selecting the second resource configuration based on failing to detect the reservation signal from the third UE.

Some examples of the method, apparatuses, and non-transitory computer-readable medium described herein may further include operations, features, means, or instructions for receiving, from a base station, control signaling indicating the first resource configuration or the second resource configuration for the set of symbols, where selecting the sidelink channel resource configuration includes selecting the indicated first resource configuration or the second resource configuration.

Some examples of the method, apparatuses, and non-transitory computer-readable medium described herein may further include operations, features, means, or instructions for receiving, from a base station, control signaling indicating the first resource configuration and the second resource configuration for the set of symbols.

Some examples of the method, apparatuses, and non-transitory computer-readable medium described herein may further include operations, features, means, or instructions for determining one or more parameters associated with the data transmission, where selecting the sidelink channel resource configuration may be based on the one or more parameters.

In some examples of the method, apparatuses, and non-transitory computer-readable medium described herein, the one or more parameters include a priority associated with the data transmission, a channel busy ratio associated with the sidelink communications, a geographic location of the first UE, a type of the data transmission, or a combination thereof.

Some examples of the method, apparatuses, and non-transitory computer-readable medium described herein may further include operations, features, means, or instructions for determining, based on one or more parameters associated with the sidelink communications, to transmit a first message or a second message based on a priority of the first message and the second transmission, a length of the first message and the second transmission, or a combination thereof.

In some examples of the method, apparatuses, and non-transitory computer-readable medium described herein, the one or more parameters associated with the sidelink communications include a first set of resources associated with the feedback message at least partially overlapping with a second set of resources associated with the data transmission, a power scaling procedure for the sidelink communications performed by the first UE, the first UE receiving a reservation signal from a third UE, or a combination thereof.

In some examples of the method, apparatuses, and non-transitory computer-readable medium described herein, the two or more second TTIs include a first second TTI spanning a first quantity of the set of symbols and a second second TTI spanning a second quantity of the set of symbols different than the first quantity.

In some examples of the method, apparatuses, and non-transitory computer-readable medium described herein, the single first TTI and each of the two or more second TTIs each include a first symbol associated with automatic gain control (AGC), one or more second symbols associated with a physical sidelink control channel (PSCCH), one or more third symbols associated with a physical sidelink data channel (PSSCH), a fourth symbol associated with a gap symbol, or a combination thereof.

A method for wireless communication at a first UE is described. The method may include determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI, selecting, from the first resource configuration and the second resource configuration, a sidelink channel resource configuration for receiving a data transmission from the second UE, and receiving the data transmission from the second UE according to the selected sidelink channel resource configuration.

An apparatus for wireless communication at a first UE is described. The apparatus may include a processor and memory coupled with the processor. The processor and memory may be configured to determine, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI, select, from the first resource configuration and the second resource configuration, a sidelink channel resource configuration for receiving a data transmission from the second UE, and receive the data transmission to the second UE according to the selected sidelink channel resource configuration.

Another apparatus for wireless communication at a first UE is described. The apparatus may include means for determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI, means for selecting, from the first resource configuration and the second resource configuration, a sidelink channel resource configuration for receiving a data transmission from the second UE, and means for receiving the data transmission to the second UE according from the selected sidelink channel resource configuration.

A non-transitory computer-readable medium storing code for wireless communication at a first UE is described. The code may include instructions executable by a processor to determine, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI, select, from the first resource configuration and the second resource configuration, a sidelink channel resource configuration for receiving a data transmission from the second UE, and receive the data transmission from the second UE according to the selected sidelink channel resource configuration.

Some examples of the method, apparatuses, and non-transitory computer-readable medium described herein may further include operations, features, means, or instructions for monitoring, during a first symbol of the set of symbols, for a reservation signal received from a third UE for one or more symbols within the set of symbols, where selecting the sidelink channel resource configuration may be based on the monitoring.

Some examples of the method, apparatuses, and non-transitory computer-readable medium described herein may further include operations, features, means, or instructions for receiving, from a base station, control signaling indicating the first resource configuration or the second resource configuration for the set of symbols, where selecting the sidelink channel resource configuration includes selecting the indicated first resource configuration or the second resource configuration.

A method for wireless communication at a first UE is described. The method may include receiving, from a base station, signaling indicating a set of possible resource configurations for a set of symbols for sidelink communications between the first UE and a second UE, each possible resource configuration including two or more TTIs spanning the set of symbols, receiving, from the second UE, an indication of one or more TTI lengths indicating a sidelink channel resource configuration from the set of possible resource configurations, and communicating with the second UE according to the sidelink channel resource configuration.

An apparatus for wireless communication at a first UE is described. The apparatus may include a processor and memory coupled with the processor. The processor and memory may be configured to receive, from a base station, signaling indicating a set of possible resource configurations for a set of symbols for sidelink communications between the first UE and a second UE, each possible resource configuration including two or more TTIs spanning the set of symbols, receive, from the second UE, an indication of one or more TTI lengths indicating a sidelink channel resource configuration from the set of possible resource configurations, and communicate with the second UE according to the sidelink channel resource configuration.

Another apparatus for wireless communication at a first UE is described. The apparatus may include means for receiving, from a base station, signaling indicating a set of possible resource configurations for a set of symbols for sidelink communications between the first UE and a second UE, each possible resource configuration including two or more TTIs spanning the set of symbols, means for receiving, from the second UE, an indication of one or more TTI lengths indicating a sidelink channel resource configuration from the set of possible resource configurations, and means for communicating with the second UE according to the sidelink channel resource configuration.

A non-transitory computer-readable medium storing code for wireless communication at a first UE is described. The code may include instructions executable by a processor to receive, from a base station, signaling indicating a set of possible resource configurations for a set of symbols for sidelink communications between the first UE and a second UE, each possible resource configuration including two or more TTIs spanning the set of symbols, receive, from the second UE, an indication of one or more TTI lengths indicating a sidelink channel resource configuration from the set of possible resource configurations, and communicate with the second UE according to the sidelink channel resource configuration.

Some examples of the method, apparatuses, and non-transitory computer-readable medium described herein may further include operations, features, means, or instructions for receiving, from the second UE, a second indication of a pattern of TTIs within the set of symbols, where a combination of the indication of one or more TTI lengths and the pattern of TTIs indicates the sidelink channel resource configuration.

In some examples of the method, apparatuses, and non-transitory computer-readable medium described herein, communicating with the second UE may include operations, features, means, or instructions for monitoring a first TTI of the two or more TTIs and transmitting, based on the monitoring, a feedback message within a second TTI of the two or more TTIs indicating whether communications from the second UE may be received in the first TTI.

In some examples of the method, apparatuses, and non-transitory computer-readable medium described herein, the sidelink channel resource configuration may be for communications between the first UE and the second UE via a first component carrier, the method further including.

Some examples of the method, apparatuses, and non-transitory computer-readable medium described herein may further include operations, features, means, or instructions for monitoring the first component carrier during a first TTI of the two or more TTIs, monitoring the second component carrier during a second TTI of the two or more TTIs, and transmitting, based on monitoring the first component carrier and the second component carrier, a feedback message indicating whether communications from the second UE may be received via the first component carrier and the second component carrier.

Some examples of the method, apparatuses, and non-transitory computer-readable medium described herein may further include operations, features, means, or instructions for monitoring the first component carrier during a first TTI of the two or more TTIs, monitoring the second component carrier during a second TTI of the two or more TTIs, transmitting, based on monitoring the first component carrier, a first feedback message indicating whether communications from the second UE may be received via the first component carrier, and transmitting, based on monitoring the second component carrier, a second feedback message indicating whether communications from the second UE may be received via the second component carrier.

In some examples of the method, apparatuses, and non-transitory computer-readable medium described herein, communicating with the second UE may include operations, features, means, or instructions for transmitting a signal, during a first TTI of the two or more TTIs, reserving one or more symbols for communicating with the second UE in the first TTI and communicating with the second UE in the reserved one or more symbols in the first TTI.

In some examples of the method, apparatuses, and non-transitory computer-readable medium described herein, the signal indicates a periodicity for communicating with the second UE in the reserved one or more symbols of the first TTI and communicating with the second UE further includes communicating with the second UE in the reserved one or more symbols of the first TTI within two or more additional sets of symbols in accordance with the indicated periodicity.

In some examples of the method, apparatuses, and non-transitory computer-readable medium described herein, communicating with the second UE may include operations, features, means, or instructions for transmitting a signal, during a first TTI of the two or more TTIs, reserving one or more symbols for communicating with the second UE in a second TTI of the two or more TTIs and communicating with the second UE in the reserved one or more symbols in the second TTI.

In some examples of the method, apparatuses, and non-transitory computer-readable medium described herein, the signal indicates a periodicity for communicating with the second UE in the reserved one or more symbols of the second TTI and communicating with the second UE further includes communicating with the second UE in the reserved one or more symbols of the second TTI within two or more additional sets of symbols in accordance with the indicated periodicity.

In some examples of the method, apparatuses, and non-transitory computer-readable medium described herein, at least one of the possible resource configurations includes two TTIs each spanning one or more of the set of symbols and configured for physical sidelink feedback channel communications between the first UE and the second UE.

In some examples of the method, apparatuses, and non-transitory computer-readable medium described herein, each possible resource configuration indicates a subchannel size, a quantity of subchannels, a feedback configuration, a reference signal configuration, a duration of a physical sidelink control channel, or a combination thereof.

In some examples of the method, apparatuses, and non-transitory computer-readable medium described herein, receiving signaling may include operations, features, means, or instructions for receiving radio resource control signaling from the base station.

A method for wireless communication at a first UE is described. The method may include receiving, from a base station, signaling indicating a set of possible resource configurations for a set of symbols for sidelink communications between the first UE and a second UE, each possible resource configuration including two or more TTIs spanning the set of symbols, transmitting, to the second UE, an indication of one or more TTI lengths indicating a sidelink channel resource configuration from the set of possible resource configurations, and communicating with the second UE according to the sidelink channel resource configuration.

An apparatus for wireless communication at a first UE is described. The apparatus may include a processor and memory coupled with the processor. The processor and memory may be configured to receive, from a base station, signaling indicating a set of possible resource configurations for a set of symbols for sidelink communications between the first UE and a second UE, each possible resource configuration including two or more TTIs spanning the set of symbols, transmit, to the second UE, an indication of one or more TTI lengths indicating a sidelink channel resource configuration from the set of possible resource configurations, and communicate with the second UE according to the sidelink channel resource configuration.

Another apparatus for wireless communication at a first UE is described. The apparatus may include means for receiving, from a base station, signaling indicating a set of possible resource configurations for a set of symbols for sidelink communications between the first UE and a second UE, each possible resource configuration including two or more TTIs spanning the set of symbols, means for transmitting, to the second UE, an indication of one or more TTI lengths indicating a sidelink channel resource configuration from the set of possible resource configurations, and means for communicating with the second UE according to the sidelink channel resource configuration.

A non-transitory computer-readable medium storing code for wireless communication at a first UE is described. The code may include instructions executable by a processor to receive, from a base station, signaling indicating a set of possible resource configurations for a set of symbols for sidelink communications between the first UE and a second UE, each possible resource configuration including two or more TTIs spanning the set of symbols, transmit, to the second UE, an indication of one or more TTI lengths indicating a sidelink channel resource configuration from the set of possible resource configurations, and communicate with the second UE according to the sidelink channel resource configuration.

Some examples of the method, apparatuses, and non-transitory computer-readable medium described herein may further include operations, features, means, or instructions for transmitting, to the second UE, a second indication of a pattern of TTIs within the set of symbols, where a combination of the indication of one or more TTI lengths and the pattern of TTIs indicates the sidelink channel resource configuration.

In some examples of the method, apparatuses, and non-transitory computer-readable medium described herein, communicating with the second UE may include operations, features, means, or instructions for transmitting, to the second UE, a message within a first TTI of the two or more TTIs and receiving, based on the monitoring, a feedback message within a second TTI of the two or more TTIs indicating whether the second UE received the message within the first TTI.

### BRIEF DESCRIPTION OF THE DRAWINGS

FIG. 1 illustrates an example of a wireless communications system that supports slot and subslot-based sidelink communication in accordance with one or more aspects of the present disclosure.

FIG. 2 illustrates an example of a wireless communications system that supports slot and subslot-based sidelink communication in accordance with one or more aspects of the present disclosure.

FIGS. 3A through 4C illustrate example resource configurations that support slot and subslot-based sidelink communication in accordance with one or more aspects of the present disclosure.

FIG. 5 illustrates an example of a process flow that supports slot and subslot-based sidelink communication in accordance with one or more aspects of the present disclosure.

FIG. 6 illustrates an example of a process flow that supports slot and subslot-based sidelink communication in accordance with one or more aspects of the present disclosure.

FIGS. 7 and 8 show block diagrams of devices that support slot and subslot-based sidelink communication in accordance with one or more aspects of the present disclosure.

FIG. 9 shows a block diagram of a communications manager that supports slot and subslot-based sidelink communication in accordance with one or more aspects of the present disclosure.

FIG. 10 shows a diagram of a system including a device that supports slot and subslot-based sidelink communication in accordance with one or more aspects of the present disclosure.

FIGS. 11 through 14 show flowcharts illustrating methods that support slot and subslot-based sidelink communication in accordance with one or more aspects of the present disclosure.

### DETAILED DESCRIPTION

In some wireless communications systems, a base station may communicate with one or more UEs via downlink signals and uplink signals. The UEs may also communicate with each other via one or more sidelink signals. In some cases, UEs may rely on shared resources (e.g., a pool of shared resources) for sidelink communications between UEs. For example, the UEs may communicate with each other on sidelink communication links using the shared resources (e.g., data resources). A shared resource pool for the sidelink communications may, in some examples, include control resources and data resources. In some cases, UEs may send or receive control signals over the control resources to reserve data resources for sidelink communications.

A UE may perform sidelink communications with another UE according to a resource configuration for the sidelink channel. For example, a set of symbols of a sidelink channel may be associated with a resource configuration. The resource configuration may indicate a subset of resources (e.g., time resources, frequency resources) within the set of resources associated with a PSCCH, PSSCH, or a physical sidelink feedback channel (PSFCH). In some cases, the resource configuration may be a slot-based resource configuration. That is, the resource configuration may indicate a transmission time interval (TTI) that spans a set of symbols associated with a slot. In some other cases, the resource configuration may be a subslot-based resource configuration. That is, the resource configuration may indicate TTIs that span less symbols than the full set of symbols (e.g., a subslot). For example, the set of symbols may include 14 symbols, and the resource configuration may indicate multiple TTIs that span less than 14 symbols (e.g., two symbols, three symbols, four symbols, seven symbols). In some cases, the multiple TTIs may collectively span the set of symbols (e.g., two TTIs that each span seven symbols may collectively span a 14 symbols in the set).

In some cases, the UE may select the resource configuration for the set of symbols based on monitoring a first symbol within the set for a reservation signal (e.g., transmitted by another UE). For example, if the UE detects a reservation symbol within the first symbol, the UE may select the slot-based resource configuration for the set of symbols. Additionally, if the UE does not detect the reservation signal in the first symbol, the UE may determine to use a subslot-based resource configuration for the set of symbols. In some other cases, the UE may select the resource configuration for the set of symbols based on control signaling received from a base station (e.g., indicating either a slot-based or subslot-based resource configuration).

In a case that a UE is configured to perform sidelink communications using a subslot-based resource configuration, the UE may select the subslot-based resource configuration from a set of possible subslot-based resource configurations based on signaling received from another UE. For example, the other UE may indicate a resource configuration (e.g., from the set of possible subslot-based resource configurations for sidelink communications) by indicating a subslot length associated with the subslot-based resource configuration. The UE may then select the subslot-based resource configuration having the indicated subslot length.

In some cases, performing sidelink communications using a subslot-based resource configurations may decrease a latency associated with sidelink communications when compared to performing sidelink communications using a slot-based resource configuration. For example, a subslot-based resource configuration may enable a UE to monitor a sidelink channel for communications from another UE and transmit feedback for the communications in a same slot.

Aspects of the disclosure are initially described in the context of wireless communications systems. Aspects of the disclosure are then described with reference to resource configurations and process flows. Aspects of the disclosure are further illustrated by and described with reference to apparatus diagrams, system diagrams, and flowcharts that relate to slot and subslot-based sidelink communication.

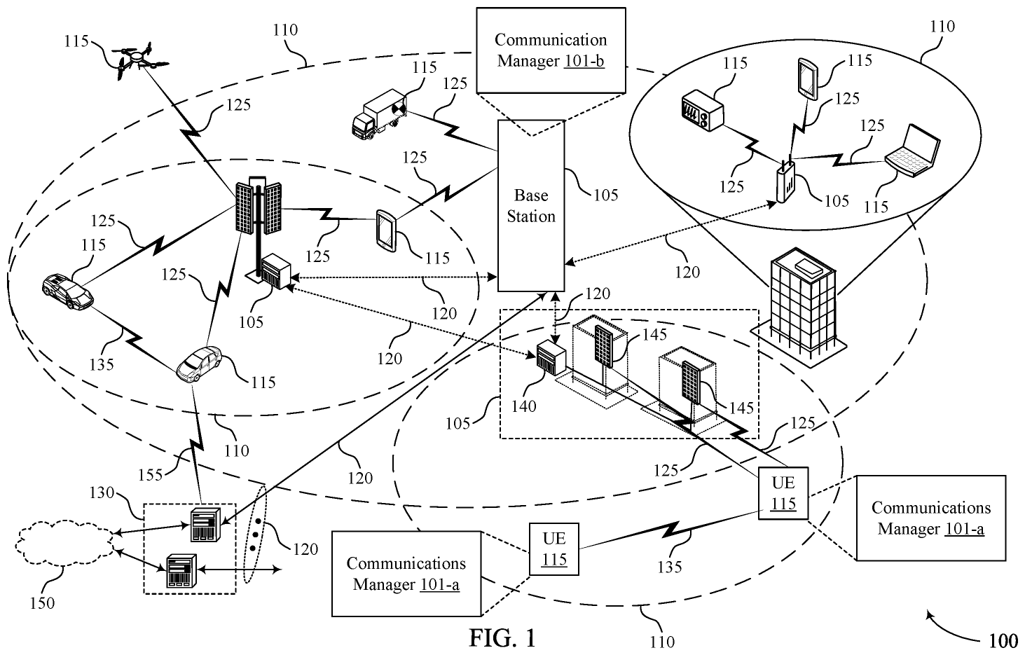

FIG. 1 illustrates an example of a wireless communications system 100 that supports slot and subslot-based sidelink communication in accordance with one or more aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. A UE 115 may communicate with the core network 130 through a communication link 155.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a TTI. In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may be configured for communications according to various frequency bands, or portions thereof (e.g., component carriers), which may include licensed bands or unlicensed or shared bands. In one example, a frequency band may refer to a frequency range (FR), which may include a set of frequency channels (e.g., a set of ARFCNs), and such frequency ranges may be non-overlapping in the frequency domain. For example, the wireless communications system 100 may support communications using a frequency range FR1, corresponding to a frequency band between 410 MHz and 7.125 GHz, a frequency range FR2, corresponding to a frequency band between 24.250 GHz and 52.600 GHz, a frequency range FR4, corresponding to a frequency band between 52.6 GHz and 71 GHz or 114.25 GHz, or various combinations of FR1, FR2, FR4, or other frequency ranges.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval. In some other cases, the device may provide HARQ feedback in a same slot. For example, the device may support subslot-based communications and may provide HARQ feedback in a subslot for data received in a previous subslot, where both the subslot and previous subslot are within a same slot.

In some wireless communications systems, UEs 115 may communicate with each other via one or more communication links 135 (e.g., a sidelink 135). In some cases, The UEs may utilize shared resources for the sidelink communications. For example, the UEs 115 may communicate with each other on sidelink communication links such as communications links 135 using the shared resources (e.g., data resources). A shared resource pool for the sidelink communications may, in some examples, include control resources and data resources. In some cases, UEs 115 may send or receive control signals over the control resources to reserve data resources for sidelink communications.

In some cases, the UEs 115 may be allocated a portion of the resources in a set of symbols (e.g., a semi-static uplink slot including a quantity of symbols). The set of symbols be include time and frequency resources that may be allocated to UEs for sidelink communications (e.g., by a base station 105) and may include one or more symbol periods, mini-slots, slots, subframes, frames, or the like. In some cases, each set of symbols (or the semi-static uplink portion of flexible TTIs) may be indicated for sidelink communications. A set of symbols (e.g., one sidelink resource pool, a semi-static uplink slot) may include a set of contiguous RBs that form a subchannel in the frequency domain. In some cases, a subchannel may be the smallest transmission and reception unit. In some cases, a UE 115 may be configured by higher layers with one or more sidelink resource pools. In some cases, the resources may be allocated to a PSSCH, a PSSCH, or a PSFCH. For example, a sidelink resource pool may be used for PSSCH transmissions and may be associated with either a first sidelink resource allocation mode (e.g., a Mode 1) or a second sidelink resource allocation mode (e.g., a Mode 2). In the frequency domain, a sidelink resource pool may consist of a number of contiguous subchannels (e.g., sl-NumSubchannel) and a sub-channel may consist of contiguous PRBs of different sizes (e.g., sl-SubchannelSize), where the number and sizes of the subchannels are higher layer parameters.

In some cases, sidelink scheduling may be slot-based. For example, PSCCH accompanied by PSSCH may be transmitted at the beginning of a set of symbols (e.g., a slot). In some cases, each PSCCH may schedule the PSSCH in the same set of symbols, and the PSCCH may also reserve some symbols in the future (e.g., in future sets of symbols or slots) for a re-transmission of the same transport block (TB). In some cases, the configuration of sidelink HARQ (e.g., via a PSFCH) may also be slot-based. For example, PSFCH resources may be available at the end of some sets of symbols indicated by an offset and periodicity. The PSFCH periodicity for a resource pool may be set by higher layers to be 0 (e.g., no PSFCH), 1, 2, or 4 slots.

A UE 115 may receive a PSSCH in a resource pool, and the HARQ feedback indicator field (e.g., enabling or disabling HARQ feedback for the PSSCH transmissions) in an associated sidelink control information (SCI) format (e.g., SCI format 2-A, SCI format 2-B) may have a value of 1. The UE 115 may provide the HARQ ACK information in a PSFCH transmission in the resource pool. In some cases, the UE 115 may transmit the PSFCH in a first TTI that may include PSFCH resources and is at least a number of slots of the resource pool after a last slot of the PSSCH reception (e.g., sl-MinTimeGapPSFCH-r16). In some cases, a minimum time between transmissions and retransmissions for slot-based sidelink channels may also be slot-based (e.g., two slots between a transmission and retransmission, three slots between a transmissions and retransmission). In some cases, slot-based sidelink channels may not support low latency communications. That is, the minimum time between transmissions and retransmissions may be longer than desirable for low latency communications.

In some cases, a UE 115 may configure sidelink channel resources when the sidelink channel supports communications based on TTIs of different lengths (e.g., other than a slot). For example, the UE 115 may support subslot-based sidelink communications, where the TTIs include less symbols when compared to slot-based sidelink communications. To support TTIs of different lengths, a UE 115 may configure sidelink channel resources using reservations or a base station may configure sidelink channel resources. In one examples, a UE 115 that supports shorter TTI-based resource configurations (e.g., subslot-based resource configurations) may monitor a first symbol of a TTI to detect any slot-based reservation symbols in the first symbol. If a UE 115 detects a slot-based reservation symbol, the UE 115 may assume a slot-based resource configuration for that TTI. In a case that a UE 115 does not detect the slot-based reservation signal in the first symbol, the UE 115 may determine to use a shorter TTI-based (e.g., subslot-based) resource configuration for the TTI. In another example, the base station 105 may indicate to the UE 115 the resource configuration to use for each TTI (e.g., slot-based or subslot-based).

In some cases, a UE 115 may determine a subslot-based resource configuration for the sidelink channel. For example, a first UE 115 may indicate, to a second UE 115, a TTI length for a set of symbols (e.g., a subslot length for the slot). In some cases, the second UE 115 may identify a subslot-based resource configuration based on the indicated TTI length. In some cases, the first UE 115 may indicate a TTI pattern to enable the second UE 115 to identify the subslot-based resource configuration. The opportunity for subslot-based resource configurations may enable a UE 115 to transmit feedback (e.g., via the PSFCH) for communications transmitted within the same set of symbols (e.g., slot). Thus, the UE 115 may support low latency sidelink communications.

In various examples, a communication manager 101 may be included in a device to support slot and subslot-based sidelink communication. For example, a UE 115 may include a communications manager 101-a, or a base station may include a communications manager 110-b.

The communication manager 101 may be configured as or otherwise support a means for determining, for a set of symbols for sidelink communications between the first UE 115 and a second UE 115, a first resource configuration including a single first TTI spanning the set of symbols and a second resource configuration including two or more second TTIs spanning the set of symbols, the two or more second TTIs each being shorter in length than the single first TTI. The communication manager 101 may be configured as or otherwise support a means for selecting, from the first resource configuration and the second resource configuration, a sidelink channel resource configuration for a data transmission to the second UE 115. communication manager 101 may be configured as or otherwise support a means for transmitting the data transmission to the second UE 115 according to the selected sidelink channel resource configuration.

Additionally or alternatively, the communication manager 101 may be configured as or otherwise support a means for determining, for a set of symbols for sidelink communications between the first UE 115 and a second UE 115, a first resource configuration including a single first TTI spanning the set of symbols and a second resource configuration including two or more second TTIs spanning the set of symbols, the two or more second TTIs each being shorter in length than the single first TTI. The communication manager 101 may be configured as or otherwise support a means for selecting, from the first resource configuration and the second resource configuration, a sidelink channel resource configuration for receiving a data transmission from the second UE 115. The communication manager 101 may be configured as or otherwise support a means for receiving the data transmission from the second UE 115 according to the selected sidelink channel resource configuration.

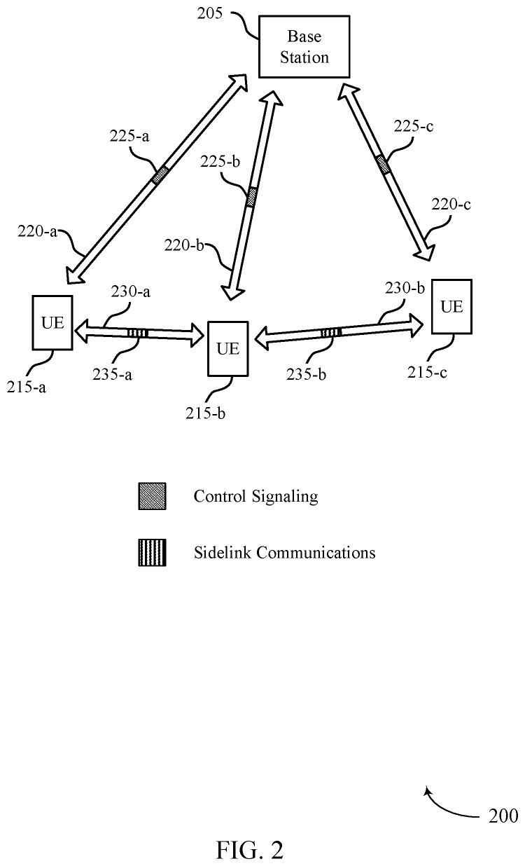

FIG. 2 illustrates an example of a wireless communications system 200 that supports slot and subslot-based sidelink communication in accordance with one or more aspects of the present disclosure. The wireless communications system 200 may include a base station 205, UEs 215, communication links 220, and sidelinks 230. In some cases, the wireless communications system may implement aspects of wireless communications systems 100. For example, a UE 215 and a base station 205 may be examples of a UE 115 and base station 105, respectively, as described with reference to FIG. 1. The wireless communications system 200 may support both slot-based and subslot-based sidelink communications. For example, the UEs 215 may communicate via sidelinks 230 using both slot-based and subslot-based resource configurations.

Each of the UEs 215 may be in communication with the base station 205 via the communication links 220. For example, UE 215-a may communicate with the base station 205 via the communication link 220-a. Additionally, UE 215-b may communicate with the base station 205 via the communication link 220-b, and UE 215-c may communicate with the base station 205 via the communication link 220-c. Additionally, the UEs 215 may communicate with each other via sidelinks 230. For example, UE 215-a may communicate with UE 215-b via sidelink 230-a and UE 215-c may communicate with UE 215-b via sidelink 230-b.

The UE 215-b may utilize a same resource pool (e.g., a same set of time and frequency resources) for sidelink communications via the sidelinks 230-a and 230-b. In some other cases, the UE 215-b may utilize different resource pools for sidelink communications via the sidelinks 230-a and 230-b. Each resource pool for the sidelink communications may be configured (e.g., preconfigured by the base station 205) with one or more possible resource configurations. For example, the base station 205 may transmit control signaling 225 to each of the UEs 215 indicating the one or more possible resource configuration for the sidelinks 230. In some cases, the control signaling 225 may include a MAC-control element (MAC-CE) preconfiguring the set of possible resource configurations for the sidelinks 230.

Based on receiving the control signaling 225, each of the UEs 215 may identify the set of possible resource configurations for the sidelinks 230. For example, the control signaling 225 may indicate one or more slot-based resource configurations for the sidelinks 230, one or more subslot-based resource configurations for the sidelinks 230, or both. The slot-based resource configurations may include, for each slot (e.g., for each set of 14 symbols corresponding to a slot), a single TTI spanning the slot and including resources for one or more of a PSCCH, a PSSCH, and a PSFCH. The subslot-based resource configurations may include, for each slot, more than one nonoverlapping TTI that collectively span the slot. Here, each of the more than one TTIs may include resources for one or more of the PSCCH, the PSSCH, and the PSFCH. Additionally, each resource configuration may indicate a subchannel size (e.g., a quantity of component carriers associated with the resource configuration), a quantity of subchannels, a demodulation reference signal (DMRS) pattern, a PSFCH configuration, a PSCCH duration, or a combination thereof.

For subslot-based resource configurations, the control signaling 225 may indicate a length of the TTIs associated with the resource configuration (e.g., a subslot length). For example, the control signaling 225 may indicate a six-symbol TTI. Here, the UE 215 may determine a subslot-based resource configuration where each set of symbols (e.g., slot) includes two seven-symbol TTIs. Additionally or alternatively, the control signaling 225 may indicate both a length of the TTIs associated with the resource configuration and a pattern of the TTIs. For example, the control signaling 225 may indicate a four-symbol TTI, a three-symbol TTI, and a four-symbol TTI and a pattern of the TTIs (e.g., the four-symbol TTI, then the three-symbol TTI, then the four-symbol TTI).

In some cases, the base station 205 may indicate that a resource pool for a sidelink 230 is associated with one possible resource configuration. Here, the one possible resource configuration may be for a resource pool that overlaps with another resource pool. For example, the base station 205 may indicate to the UEs 215-a and 215-b (e.g., via the control signaling 225-a and 225-b, respectively) one possible resource configuration for the sidelink 230-a. Additionally, the base station 205 may indicate to the UEs 215-b and 215-c (e.g., via the control signaling 225-b and 225-c, respectively) one possible resource configuration for the sidelink 230-b. In a case that the one possible resource configurations for sidelinks 230-a and 230-b are for resource pools that overlap, the base station 205 may additionally indicate (e.g., via the control signaling 225), that the one possible resource configurations are for resource pools that overlap with resource pools associated with one or more other possible resource configurations.

In order to communicate via the sidelinks 230, each of the UEs 215 may select one of the possible resource configurations for sidelink communications with another UE 215 (e.g., a sidelink channel resource configuration).

In a first example (e.g., in a case that the UEs 215 are operating under Mode 1 resource allocation where the UEs 215 do not have to perform a sensing procedure prior to transmitting via the sidelinks 230), the base station 205 may indicate, to the UEs 215, whether the sidelinks 230 are associated with slot-based or subslot-based resource configurations. For example, the base station 205 may transmit, to each of the UEs 215, control signaling 225 indicating whether the sidelink resource configuration is associated with a single TTI (e.g., corresponding to a slot-based resource configuration) or more than one TTI shorter than the single TTI (e.g., corresponding to a subslot-based resource configuration). In some cases, the control signaling 225 indicating whether the sidelinks 230 are associated with slot or subslot-based resource configurations may be dynamic. For example, the base station 205 may transmit control signaling 225 via downlink control information (DCI) (e.g., DCI format 3-x). In this example, one or more of the UEs 215 may indicate additional parameters associated with the sidelink channel resource configuration via SCI. For example, the UE 215-b may indicate, to each of the UEs 215-a and 215-c, a slot or subslot length within SCI. That is, the UE 215-b may indicate a quantity of symbols within one or more of the TTIs associated with the sidelink channel resource configuration for the sidelinks 230-a and 230-b.

In this example, the UEs 215 may select the sidelink channel resource configuration from the set of possible resource configurations for the sidelinks based on receiving the control signaling 225 from the base station 205 (e.g., indicating a slot or subslot-based resource configuration, indicating one of the possible resource configurations), based on receiving the indication of slot or subslot-lengths from another UE 215, or both.

In a second example (e.g., in a case that the UEs 215 are operating under Mode 2 resource allocation where the UEs 215 do perform a sensing procedure prior to transmitting via the sidelinks 230), the UEs 215 may select the sidelink channel resource configuration from the set of possible resource configurations based on monitoring a first symbol (e.g., of a set of symbols of the sidelink 230) for a reservation signal from another UE 215. In a case that the UE 215 detects a reservation signal from another UE 215 (e.g., reserving one or more symbols within the set of symbols for communications), the UE 215 may select a sidelink channel resource configuration that is based on the reservation signal. For example, the UE 215-c may detect, while monitoring the first symbol, a reservation signal from the UE 215-b, where the reservation signal is a slot-based reservation signal (e.g., reserving resources according to a slot-based resource configuration for the sidelink 230-b). Here, the UE 215-c may select a slot-based resource configuration for the sidelink channel resource configuration.

Additionally, in a case that a UE 215 fails to detect a reservation signal from another UE 215 while monitoring the first symbol, the UE 215 may select either a slot-based or subslot-based sidelink channel resource configuration (e.g., based on one or more additional parameters). For example, the UE 215 may select a slot-based versus a subslot-based sidelink channel resource configuration based on its capability (e.g., if the UE 215 is capable of subslot-based sidelink communications), a priority of a data transmission via the sidelink 230 (e.g., based on a proSe-per-packet priority (PPPP)), a quality of service (e.g., a constate bitrate (CBR)) associated with the sidelink 230, a geographic location of the UE 215 (e.g., a zone identifier), a cast type of the sidelink communication (e.g., broadcast, multicast, unicast), or a combination thereof.

In cases that the UE 215 determines to select a subslot-based resource configuration for the sidelink channel resource configuration, the UE 215 may additionally determine, from a set of multiple possible subslot-based resource configurations, a subslot-based resource configuration for the sidelink 230. For example, the UE 215-b may select a subslot-based resource configuration based on receiving signaling from the UE 215-a (e.g., via an SCI field) indicating one of the possible subslot-based resource configurations. The signaling may indicate a length of a TTI associated with the subslot-based resource configuration. For example, the UE 215-a may transmit an indication of a six-symbol TTI to the UE 215-b and the UE 215-b may select a subslot-based resource configuration that has subslots having a length of the indicated TTI length (e.g., six symbols). Additionally, the signaling may indicate a pattern of TTI lengths associated with the subslot-based resource configuration. For example, the UE 215-a may transmit an indication of a three-symbol TTI, followed by a four-symbol TTI, followed by another four-symbol TTI, and the UE 215-b may select the subslot-based resource configuration having that indicated pattern of TTIs.

Based on selecting the sidelink channel resource configuration, the UEs 215 may communicate sidelink communications 235 via the sidelinks 230. For example, UEs 215-a and 215-b may communicate sidelinks communication 235-a via the sidelink 230-a and UEs 215-b and 215-c may communicate sidelink communications 235-b via the sidelink 230-b. The sidelink communications 235 may include transmissions via PSCCH, a PSSCH, or a PSFCH. For example, a UE 215 may communicate SCI via resources associated with a PSCCH (e.g., as indicated by the sidelink channel resource configuration). Additionally, a UE 215 may communicate data transmissions via resources associated with a PSSCH (e.g., as indicated by the sidelink channel resource configuration).

In some cases, the sidelink channel resource configuration may additionally indicate resources within a set of symbols (e.g., a slot) for a PSFCH. That is, the sidelink resource configuration may indicate one or more symbols within the set of symbols for PSFCH transmissions. Additionally, the sidelink resource configuration may indicate a processing timeline or gap between a PSSCH and corresponding PSFCH configuration. In some instances (e.g., for subslot-based sidelink channel resource configurations), a UE 215 may be configured to provide feedback (e.g., via the PSFCH resources) for data transmissions received via the PSSCH within a same set of symbols.

In some instances, a UE 215 may prioritize one sidelink communication 235 over another sidelink communication 235. For example, a UE 215 may be unable to support simultaneous transmission or reception of PSSCH and PSFCH on the same or different resources (e.g., component carriers, resource pools) and some transmissions may be dropped. That is, the UE 215 may drop one or more transmissions to avoid a collision (e.g., a sidelink collision, an uplink/downlink collision). The UE 215 may drop transmissions with a lower priority (when compared to another overlapping transmission). Additionally, a UE 215 may prioritize one sidelink communication 235 over another sidelink communication 235 based on a length of each sidelink communication. For example, if a UE 215 is configured to transmit a first PSFCH transmission in response to a slot-based PSSCH transmission and a second PSFCH transmission in response to a subslot-based PSSCH transmission and is unable to transmit both, the UE may transmit the PSFCH transmission based on a length of the associated PSSCH transmission (e.g., may prioritize the second PSFCH transmission based on the associated PSSCH transmission being subslot-based, may prioritize the first PSFCH transmission based on the associated PSSCH transmission being slot-based). In some cases, the UE 215 may rely on sidelink preemption in favor of a reservation (e.g., for a sidelink communication 235) made by another UE 215.

Additionally or alternatively, a UE 215 may perform power scaling when a power of the UE 215 is limited.

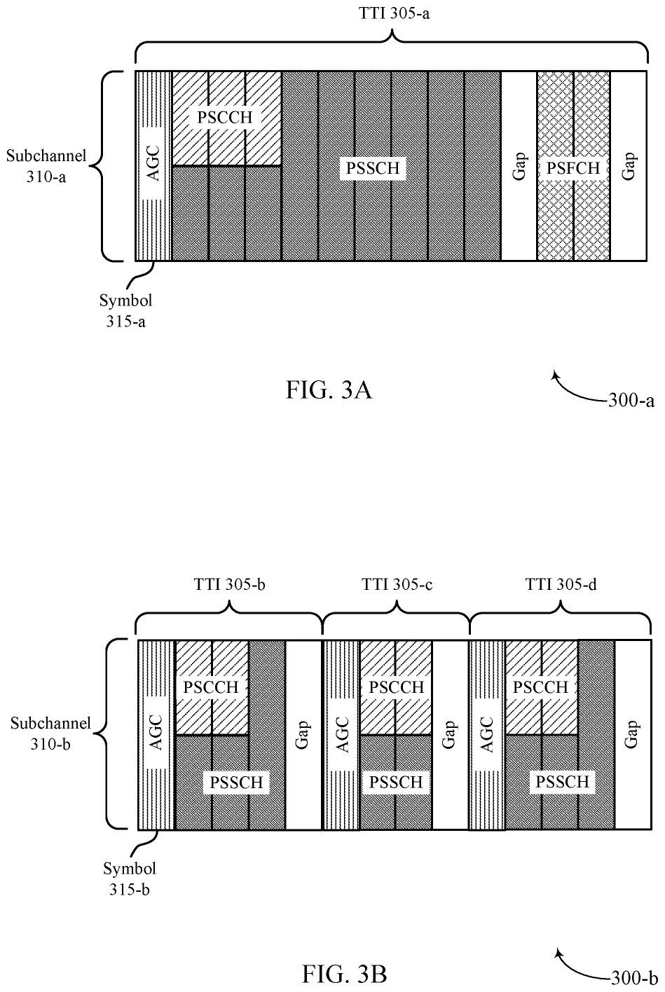

FIGS. 3A and 3B illustrate example resource configurations 300 that supports slot and subslot-based sidelink communication in accordance with one or more aspects of the present disclosure. In some cases, the resource configurations 300 may illustrate example resource configurations as described with reference to FIGS. 1 and 2. For example, a base station 105 or 205 may preconfigure resource pools with one or more of the resource configurations 400. Additionally, one or more of the UEs 115 or 215 may rely on the resource configurations 300 for sidelink communications. Here, resource configuration 300-a may illustrate an example slot-based resource configuration 300-a and the resource configuration 300-b may illustrate an example subslot-based resource configuration 300-b.

FIG. 3A illustrates an example slot-based resource configuration 300-a that includes a single TTI 305-a that spans a subchannel 310-a and includes a set of symbols 315. The example resource configuration 300-a includes resources for a PSCCH, a PSSCH, and a PSFCH. The resource configuration 300-a may additionally include one or more AGC symbols. The AGC symbols may include time resources for a device (e.g., a UE, a base station) to perform an AGC procedure (e.g., a power scaling procedure). In some cases, the AGC symbol may include resources associated with a channel (e.g., a PSSCH, a PSCCH, or both). The resource configuration 300-a may additionally include one or more gap symbols. The gap symbols may separate the resources associated with the PSFCH from the resources associated with the PSCCH and the PSSCH.

A UE may determine to use the resource configuration 300-a based on determining to use a slot-based resource configuration 300-a (e.g., instead of a subslot-based resource configuration 300-b). For example, the UE may be configured to monitor a first symbol 315-a of the set of symbols (e.g., the slot) and determine to use the slot-based resource configuration 300-a based on detecting a reservation signal associated with a slot-based resource configuration within the symbol 315-a. In another example, the UE may determine to use the slot-based resource configuration 300-a for sidelink communications based on receiving signaling (e.g., from another UE, from a base station). For example, a base station may signal, to the UE, to utilize a slot-based resource configuration 300-a. In another example, the UE may determine to use the slot-based resource configuration 300-a based on a capability of the UE. That is, the UE may not be configured to utilize a subslot-based resource configuration 300-b for sidelink communications.

Additionally or alternatively, the UE may determine to use the slot-based resource configuration 300-a based on one or more additional parameters (e.g., associated with a sidelink data transmission). For example, the UE may determine to use the slot-based resource configuration 300-a (e.g., instead of a subslot-based resource configuration 300-b) based on the priority of the sidelink data transmission being relatively low, a quality of service associated with the sidelink being below a certain threshold, a geographic location of the UE, or a cast type of the sidelink communication (e.g., broadcast, multicast, unicast).

FIG. 3B illustrates an example subslot-based resource configuration 300-b that includes three TTIs 305-b, 305-c, and 305-d. Each of the TTIs 305 span the subchannel 310-b and include a quantity of symbols 315. For example, the TTI 305-b includes four symbols 315, the TTI 305-c includes three symbols 315, and the TTI 305-d includes four symbols 315. The resource configuration 300-b may include resources (e.g., time resources, frequency resources) associated with a PSCCH and a PSSCH. In some other cases, a resource configuration 300 may be subslot-based and may additionally include resources associated with a PSFCH. The resource configuration 300-b may additionally include one or more AGC symbols. The AGC symbols may include time resources for a device (e.g., a UE, a base station) to perform an AGC procedure (e.g., a power scaling procedure). In some cases, the AGC symbol may include resources associated with a channel (e.g., a PSSCH, a PSCCH, or both). The resource configuration 300-b may additionally include one or more gap symbols. The gap symbols may separate each TTI 305-b (e.g., subslot) within the resource configuration 300-b.

In some cases, a UE may use the resource configuration 300-b based on determining to use a subslot-based resource configuration 300-b (e.g., instead of a slot-based resource configuration 300-a). For example, the UE may be configured to monitor a first symbol 315-b of the set of symbols (e.g., the slot) and determine to use the subslot-based resource configuration 300-b based on failing to detect a reservation signal associated with a slot-based resource configuration. In another example, the UE may determine to use the subslot-based resource configuration 300-b for sidelink communications based on receiving signaling (e.g., from another UE, from a base station). For example, a base station may signal, to the UE, to utilize a subslot-based resource configuration 300-b. Additionally, the base station may indicate a length of one or more of the TTIs 305. In another example, another UE may indicate, to the UE, to use the resource configuration 300-b. For example, the UE may indicate a length of one or more the TTIs 305. Additionally or alternatively, the UE may indicate a length and pattern of the one or more TTIs. For example, the other UE may indicate for the UE to use a resource configuration 300-b including a first TTI 305-b having five symbols 315, a second TTI 305-c having four symbols 315, and a third TTI 305-d having five symbols.

Additionally or alternatively, the UE may determine to use the subslot-based resource configuration 300-b based on one or more additional parameters (e.g., associated with a sidelink data transmission). For example, the UE may determine to use the subslot-based resource configuration 300-b (e.g., instead of a subslot-based resource configuration 300-a) based on the priority of the sidelink data transmission being relatively high, a quality of service associated with the sidelink being above a certain threshold, a geographic location of the UE, or a cast type of the sidelink communication (e.g., broadcast, multicast, unicast).

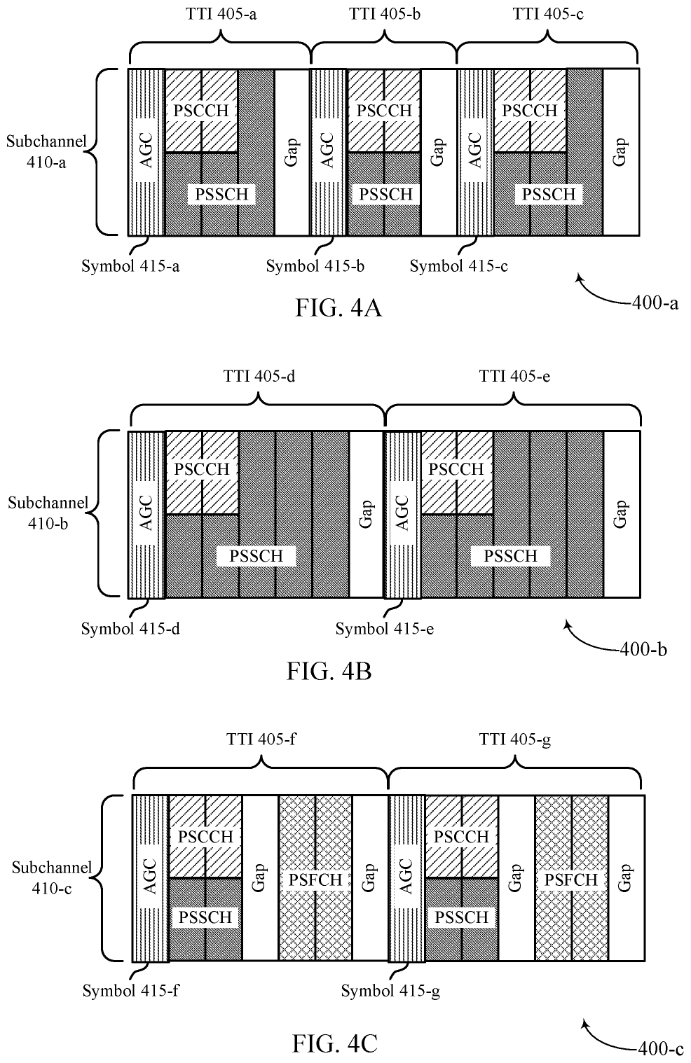

FIGS. 4A through 4C illustrate example resource configurations 400 that supports slot and subslot-based sidelink communication in accordance with one or more aspects of the present disclosure. In some cases, the resource configurations 400 may illustrate example subslot resource configurations 400 as described with reference to FIGS. 1 and 2. For example, a base station 105 or 205 may preconfigure resource pools with one or more of the resource configurations 400. Additionally, one or more of the UEs 115 or 215 may rely on the resource configurations 400 for sidelink communications.

For subslot-based resource configurations 400, a unit of resource reservation may be based on the set of symbols 415 (e.g., the slot) or may be based on each TTI 405 (e.g., the subslots). In a first case, a UE may rely on slot-based reservations to reserve resources for a PSSCH transmission. For example, the UE may reserve resources within a first TTI 405 for each set of symbols (e.g., slot) having that resource configuration 400. That is, the UE may monitor the PSSCH within the first TTI 405 for reserved data transmissions and retransmissions. Here, a periodicity of the reservations may be signaled within each set of symbols 415 (e.g., each slot). In another case, a UE may rely on subslot-based reservations to reserve resources for a PSSCH transmission. For example, the UE may reserve resources within more than one TTI of a set of symbols for PSSCH transmissions and retransmissions. That is, a UE may reserve resources within a first TTI 405 and a second TTI 405 for PSSCH transmissions. Here, a periodicity of the reservations may be signaled in each TTI 405 (e.g., each subslot).

FIG. 4A illustrates an example subslot-based resource configuration 400-a that includes three TTIs 405-a, 405-b, and 405-c. Each of the TTIs 405 span the subchannel 410-a and include a quantity of symbols 415. For example, the TTI 405-a includes four symbols 415, the TTI 405-b includes three symbols 415, and the TTI 405-c includes four symbols 415. The resource configuration 400-a may include resources (e.g., time resources, frequency resources) associated with a PSCCH and a PSSCH. In some other cases, a resource configuration 400 may be subslot-based and may additionally include resources associated with a PSFCH. The resource configuration 400-a may additionally include one or more AGC symbols. The AGC symbols may include time resources for a device (e.g., a UE, a base station) to perform an AGC procedure (e.g., a power scaling procedure). In some cases, the AGC symbol may include resources associated with a channel (e.g., a PSSCH, a PSCCH, or both). The resource configuration 400-a may additionally include one or more gap symbols. The gap symbols may separate each TTI 405 (e.g., subslot) within the resource configuration 400-a.

In some cases, a UE may use the resource configuration 400-a based on determining to use a subslot-based resource configuration 400 (e.g., instead of a slot-based resource configuration). Additionally, the UE may select the subslot-based resource configuration 400-a (e.g., from a set of subslot-based resource configurations 400) based on receiving an indication of the resource configuration 400-a from another UE. For example, the other UE may indicate a length of one or more the TTIs 405. Here, the UE may identify the resource configuration 400-a based on the indicated TTI length. Additionally or alternatively, the other UE may indicate a length and pattern of the one or more TTIs 405. For example, the other UE may indicate for the UE to use a resource configuration 400-a including a first TTI 405-a having five symbols 415, a second TTI 405-b having four symbols 415, and a third TTI 405-c having five symbols.

FIG. 4B illustrates an example subslot-based resource configuration 400-b that includes two TTIs 405-d and 405-e. Each of the TTIs 405 span the subchannel 410-b and include a quantity of symbols 415. For example, the TTIs 405-d and 405-e include six symbols 415 separated by a gap symbols. The resource configuration 400-b may include resources (e.g., time resources, frequency resources) associated with a PSCCH and a PSSCH. In some other cases, a resource configuration 400 may be subslot-based and may additionally include resources associated with a PSFCH.

In some cases, a UE may use the resource configuration 400-b based on determining to use a subslot-based resource configuration 400 (e.g., instead of a slot-based resource configuration). Additionally, the UE may select the subslot-based resource configuration 400-b (e.g., from a set of subslot-based resource configurations 400) based on receiving an indication of the resource configuration 400-b from another UE. For example, the other UE may indicate a length of one or more the TTIs 405 (e.g., six symbols). Here, the UE may identify the resource configuration 400-b based on the indicated TTI length. Additionally or alternatively, the other UE may indicate a length and pattern of the one or more TTIs 405. For example, the other UE may indicate for the UE to use a resource configuration 400-b including a first TTI 405-d having seven symbols 415, and a second TTI 405-e having seven symbols.

FIG. 4C illustrates an example subslot-based resource configuration 400-c that includes two TTIs 405-f and 405-g. Each of the TTIs 405 span the subchannel 410-c and include a quantity of symbols 415. For example, the TTIs 405-f and 405-g include six symbols 415. The resource configuration 400-c may include resources (e.g., time resources, frequency resources) associated with a PSCCH, a PSSCH, and a PSFCH. The resource configuration 400-c may additionally include one or more gap symbols. The resource configuration 400-c may additionally include one or more AGC symbols. The AGC symbols may include time resources for a device (e.g., a UE, a base station) to perform an AGC procedure (e.g., a power scaling procedure). In some cases, the AGC symbol may include resources associated with a channel (e.g., a PSSCH, a PSCCH, or both). The gap symbols may separate each TTI 405 (e.g., subslot) within the resource configuration 400-c.

In some cases, a UE may use the resource configuration 400-c based on determining to use a subslot-based resource configuration 400 (e.g., instead of a slot-based resource configuration). Additionally, the UE may select the subslot-based resource configuration 400-c (e.g., from a set of subslot-based resource configurations 400) based on receiving an indication of the resource configuration 400-c from another UE. For example, the other UE may indicate a length of one or more the TTIs 405 (e.g., six symbols). Here, the UE may identify the resource configuration 400-c based on the indicated TTI length. Additionally or alternatively, the other UE may indicate a length and pattern of the one or more TTIs 405. For example, the other UE may indicate for the UE to use a resource configuration 400-c including a first TTI 405-f having seven symbols 415 and a second TTI 405-g having seven symbols.

For subslot-based resource configurations 400 including resources for PSFCH transmissions, a periodicity of the PSFCH may be slot based. That is, the resource allocation for the PSFCH indicated by the resource configuration 400 may be present in each set of symbols 415 (e.g., slot). In another case, the periodicity of the PSFCH may be subslot-based. That is, the resource allocation for the PSFCH indicated by the resource configuration 400 may be present in each TTI 405 (e.g., subslot).

Multiple PSFCH configurations may be defined and one of the multiple PSFCH configurations may be indicated for the resource configuration 400 (or the resource pool associated with the resource configuration 400). In cases that a resource pool is associated with more than one resource configuration 400, a PSFCH configuration may be configured separately for each resource pool (e.g., instead of each resource configuration). Additionally a minimum time gap between PSSCH transmissions and a corresponding PSFCH transmission (e.g., a sl-MinTimeGapPSFCH) may be configured separately for a given TTI 405 length (e.g., may be subslot-based rather than slot-based).

In some cases, UEs may exchange sidelink communications via more than one component carrier. In instances that each of the component carriers are associated with different resource configurations 400, the UE may determine whether to transmit a single feedback message (e.g., via a PSFCH) for data transmissions received via component carriers associated with different resource configurations 400 or different feedback messages for data transmissions received via component associated with different resource configurations 400. In a first example, the UE may be configured to transmit a single feedback message for transmissions received via component carriers having different resource configurations 400. Here, the UE may transmit a single feedback message for both slot-based and subslot-based transmissions. Additionally, the UE may transmit the feedback messages based on a smallest minimum time gap, based on a largest minimum time gap, based on a UE capability, based on fixed values dependent or independent of the lengths of the TTIs 405 associated with the transmissions, or a combination thereof. In a second example, the UE may be configured to different transmit feedback messages for transmissions received via component carriers associated with different resource configurations.

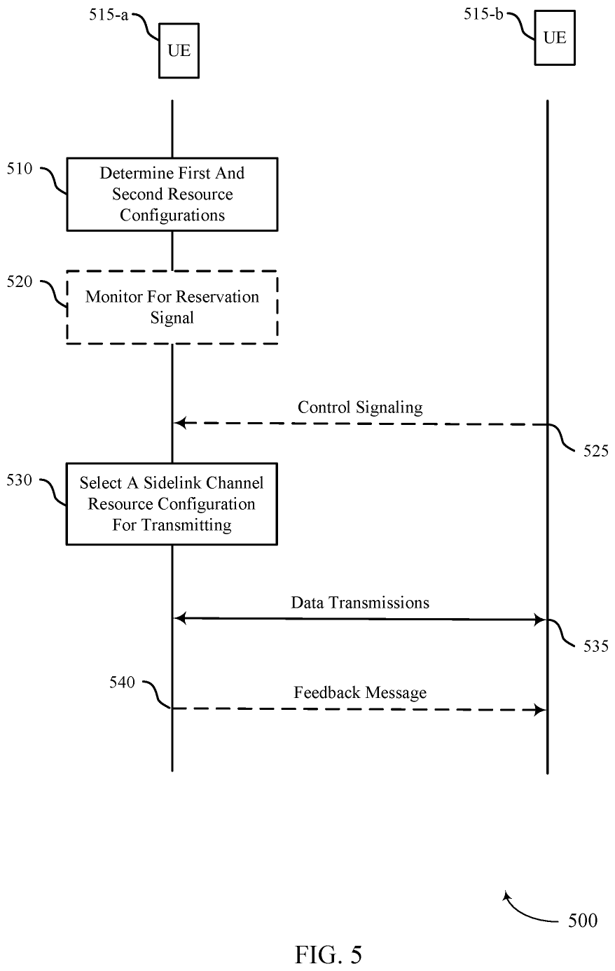

FIG. 5 illustrates an example of a process flow 500 that supports slot and subslot-based sidelink communication in accordance with one or more aspects of the present disclosure. The process flow 500 may implement aspects of wireless communications systems 100 and 200, or may be implemented by aspects of the wireless communications systems 100 and 200. For example, a UE 515-a and a UE 515-b may be examples of a UE 115, as described with reference to FIG. 1. In the following description of the process flow 500, the operations between the UE 515-a and the UE 515-b may be transmitted in a different order than the example order shown, or the operations performed by the UE 515-a and the UE 515-b may be performed in different orders or at different times. Some operations may also be omitted from the process flow 500, and other operations may be added to the process flow 500.

At 510, a first UE 515-a may determine, for a set of symbols for sidelink communications between the first UE 515-a and a second UE 515-b, a first resource configuration that may include a single first TTI that spans the set of symbols, and a second resource configuration that may include two or more second TTIs that span the set of symbols. In some cases, the two or more second TTIs may each be shorter in length than the single first TTI. In some cases, the UE 515-a may determine the resource configuration based on receiving from a base station, control signaling indicating the first resource configuration and the second resource configuration for the set of symbols.

At 520, the UE 515-a may optionally monitor, during a first symbol of the set of symbols, for a reservation signal received from a third UE 515 for one or more symbols within the set of symbols.

At 525, the UE 515-a may optionally receive control signaling from the UE 515-b. That is, the UE 515-b may optionally transmit control signaling indicating the first resource configuration or the second resource configuration for the set of symbols.

At 530, the first UE 515-a may select, from the first resource configuration and the second resource configuration, a sidelink channel resource configuration for transmitting a data transmission to the second UE 115-b. In some cases, the first UE 515-a may select a sidelink channel resource configuration for receiving a data transmission from the second UE 515-b.

In some cases, selecting the sidelink channel resource configuration may be based on the monitoring (e.g., at 520). That is, in a case that the UE 515-a detects the reservation signal from the third UE 515 during the first symbol of the set of symbols, the UE 515-a may select the first resource configuration for the sidelink channel resource configuration. Additionally, in a case that the UE 515-a fails to detect the reservation signal from the third UE 515 during the first symbol of the set of symbols, the UE 515-a may select the second resource configuration for the sidelink channel resource configuration. That is, for slot-based sidelink communications, reservations may be announced at the beginning of a set of symbols (e.g., a slot). This duration (e.g., the slot) may then be used by any UE 515 that wants to transmit a 4-symbol sub-slot based sidelink as for sensing only. Additionally, if no slot-based reservation is detected by the UE 515 (e.g., at the beginning of the slot), the remaining sub-slots within the set of symbols (e.g., the slot) may be used. That is, the UE 515 may not use the first sub-slot within the set of symbols for data transmissions with sub-slot based sidelink communications.

In some other cases, selecting the sidelink channel resource configuration may include selecting the sidelink channel resource configuration indicated by the control signaling received at 525 from the UE 515-b.

At 535, the first UE 515-a may transmit the data transmission to the second UE 515-b according to the selected sidelink channel resource configuration. In some cases, the first UE 515-a may receive the data transmission from the second UE 515-b according to the selected sidelink channel resource configuration.

At 540, the UE 515-a may optionally transmit, to the UE 515-b, a feedback message associated with a transmission from the UE 515-b. For example, the UE 515-a may receive, from the UE 515-b, control signaling via the sidelink. The UE 515-a may generate, based on a receiving the control signaling, a feedback message for transmission to the UE 515-b. The UE 515-a may then determine, based on one or more parameters associated with the sidelink communications, to transmit the feedback message or the data transmission based at least in part on a priority of the feedback message and the data transmission, a length of the feedback message and the data transmission, or a combination thereof.

In some cases of UEs 515 that are unable to simultaneously transmit and receive transmissions, the UE 515-a may generally prioritize transmissions (e.g., data transmissions, control transmissions, feedback transmissions) associated with the sidelink communications based at least in part on a length of the transmissions or a priority of the transmissions. That is, the UE 515 may identify that a first and second message overlap (e.g., at least partially overlap in time and/or frequency resources) and may thus prioritize transmitting or receiving one of the messages over the other. For example, the UE 515 may prioritize a message based on a power scaling procedure (e.g., an AGC procedure) for the sidelink communications performed by the UE 515, the UE 515 receiving a reservation signal from another UE 515, or a combination thereof.

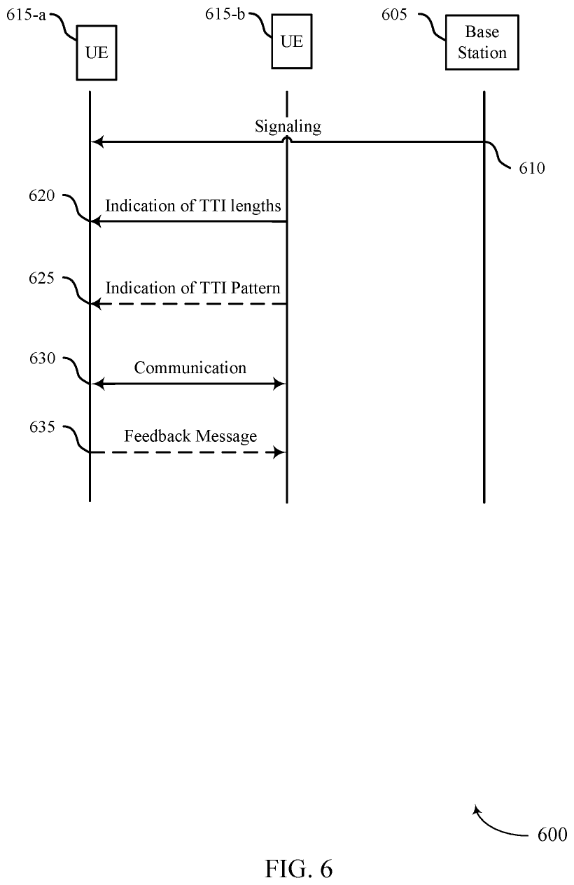

FIG. 6 illustrates an example of a process flow 600 that supports slot and subslot-based sidelink communication in accordance with one or more aspects of the present disclosure. The process flow 600 may implement aspects of wireless communications systems 100 and 200, or may be implemented by aspects of the wireless communications systems 100 and 200. For example, a UE 615-a and a UE 615-b may be examples of a UE 115, as described with reference to FIG. 1. In the following description of the process flow 600, the operations between the UE 615-a and the UE 615-b may be transmitted in a different order than the example order shown, or the operations performed by the UE 615-a and the UE 615-b may be performed in different orders or at different times. Some operations may also be omitted from the process flow 600, and other operations may be added to the process flow 600.

At 610, a first UE 615-a may receive, from a base station 605, signaling indicating a set of possible resource configurations for a set of symbols for sidelink communications between the first UE 615-a and a second UE 615-b. In some cases, each possible resource configuration may include two or more TTIs spanning the set of symbols.

At 620, the first UE 615-a may receive, from the second UE 615-b, an indication of one or more TTI lengths indicating a sidelink channel resource configuration from the set of possible resource configurations. In some cases, the first UE 615-a may transmit, to the second UE 615-b, an indication of one or more TTI lengths indicating a sidelink channel resource configuration from the set of possible resource configurations. For example, the second UE 615-b may transmit the indication of the one or more TTI lengths within a field in the SCI.

At 625, the second UE 615-b may additionally optionally transmit, to the UE 615-a, a second indication of a pattern of TTIs within the set of symbols, wherein a combination of the indication of one or more TTI lengths and the pattern of TTIs indicates the sidelink channel resource configuration. For example, the second UE 615-b may transmit the second indication of the pattern of TTIs within a field in the SCI.

At 630, the first UE 615-a may communicate with the second UE 615-a according to the sidelink channel resource configuration.

At 635, the UE 615-a may optionally transmit a feedback message associated with a communication (e.g., received at 630) to the UE 615-b. For example, the UE 615-a may monitor a first TTI of the two or more TTIs and transmit the feedback message within a second TTI of the two or more TTIs indicating whether the communications from the UE 615-b are received in the first TTI.

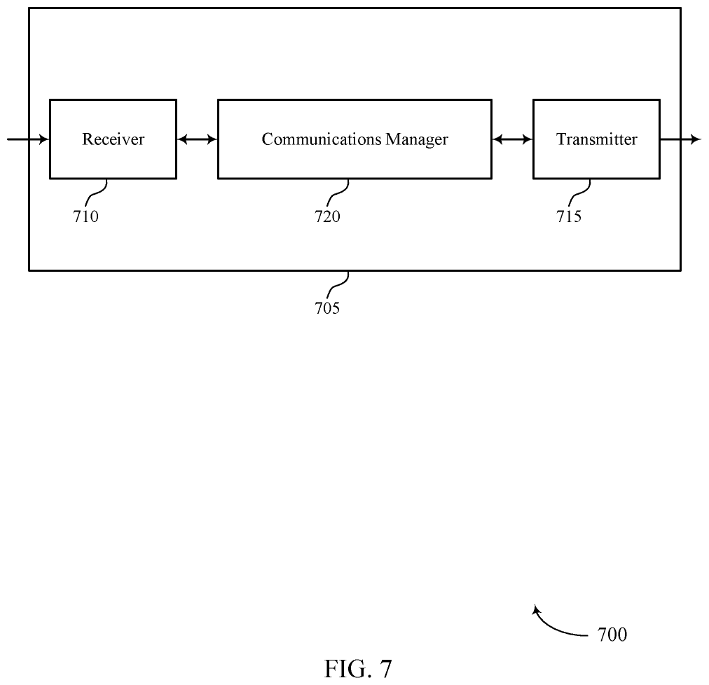

FIG. 7 shows a block diagram 700 of a device 705 that supports slot and subslot-based sidelink communication in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to slot and subslot-based sidelink communication). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to slot and subslot-based sidelink communication). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of slot and subslot-based sidelink communication as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first UE in accordance with examples as disclosed herein. For example, the communications manager 720 may be configured as or otherwise support a means for determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The communications manager 720 may be configured as or otherwise support a means for selecting, from the first resource configuration and the second resource configuration, a sidelink channel resource configuration for a data transmission to the second UE. The communications manager 720 may be configured as or otherwise support a means for transmitting the data transmission to the second UE according to the selected sidelink channel resource configuration.

Additionally or alternatively, the communications manager 720 may support wireless communication at a first UE in accordance with examples as disclosed herein. For example, the communications manager 720 may be configured as or otherwise support a means for determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The communications manager 720 may be configured as or otherwise support a means for selecting, from the first resource configuration and the second resource configuration, a sidelink channel resource configuration for receiving a data transmission from the second UE. The communications manager 720 may be configured as or otherwise support a means for receiving the data transmission from the second UE according to the selected sidelink channel resource configuration.

Additionally or alternatively, the communications manager 720 may support wireless communication at a first UE in accordance with examples as disclosed herein. For example, the communications manager 720 may be configured as or otherwise support a means for receiving, from a base station, signaling indicating a set of possible resource configurations for a set of symbols for sidelink communications between the first UE and a second UE, each possible resource configuration including two or more TTIs spanning the set of symbols. The communications manager 720 may be configured as or otherwise support a means for receiving, from the second UE, an indication of one or more TTI lengths indicating a sidelink channel resource configuration from the set of possible resource configurations. The communications manager 720 may be configured as or otherwise support a means for communicating with the second UE according to the sidelink channel resource configuration.

Additionally or alternatively, the communications manager 720 may support wireless communication at a first UE in accordance with examples as disclosed herein. For example, the communications manager 720 may be configured as or otherwise support a means for receiving, from a base station, signaling indicating a set of possible resource configurations for a set of symbols for sidelink communications between the first UE and a second UE, each possible resource configuration including two or more TTIs spanning the set of symbols. The communications manager 720 may be configured as or otherwise support a means for transmitting, to the second UE, an indication of one or more TTI lengths indicating a sidelink channel resource configuration from the set of possible resource configurations. The communications manager 720 may be configured as or otherwise support a means for communicating with the second UE according to the sidelink channel resource configuration.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for slot and subslot-based sidelink communication which may improve reliability and resource efficiency, and decrease latency. As such, supported techniques may include improved network operations and, in some examples, may promote network efficiencies, among other aspects.

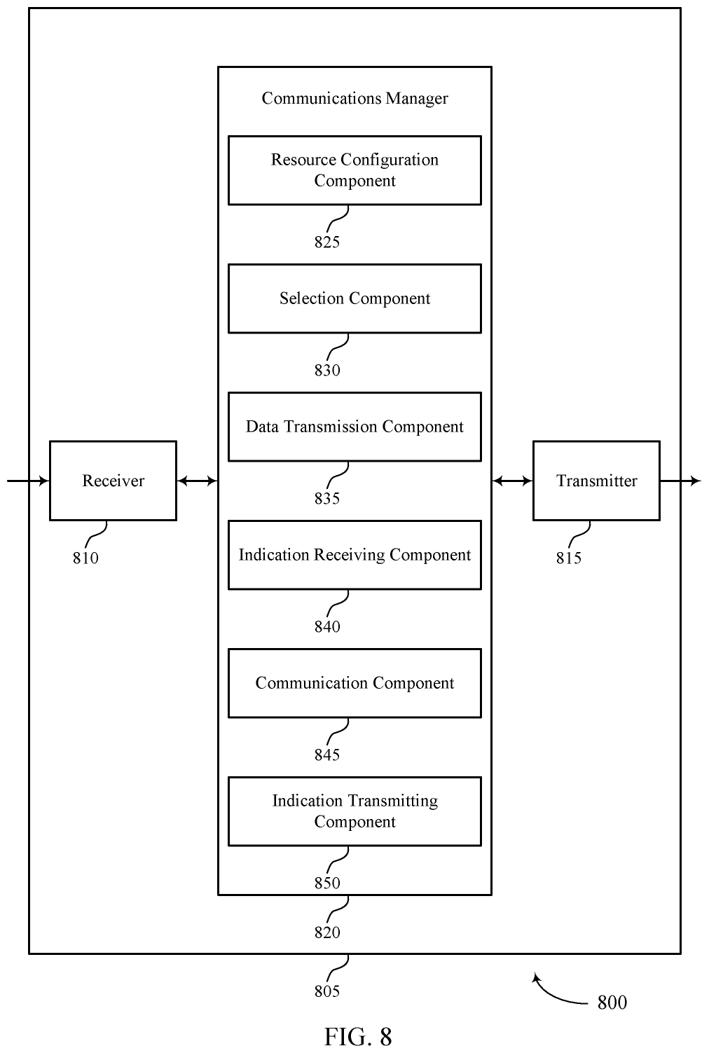

FIG. 8 shows a block diagram 800 of a device 805 that supports slot and subslot-based sidelink communication in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to slot and subslot-based sidelink communication). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to slot and subslot-based sidelink communication). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of slot and subslot-based sidelink communication as described herein. For example, the communications manager 820 may include a resource configuration component 825, a selection component 830, a data transmission component 835, an indication receiving component 840, a communication component 845, an indication transmitting component 850, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first UE in accordance with examples as disclosed herein. The resource configuration component 825 may be configured as or otherwise support a means for determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The selection component 830 may be configured as or otherwise support a means for selecting, from the first resource configuration and the second resource configuration, a sidelink channel resource configuration for a data transmission to the second UE. The data transmission component 835 may be configured as or otherwise support a means for transmitting the data transmission to the second UE according to the selected sidelink channel resource configuration.

Additionally or alternatively, the communications manager 820 may support wireless communication at a first UE in accordance with examples as disclosed herein. The resource configuration component 825 may be configured as or otherwise support a means for determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The selection component 830 may be configured as or otherwise support a means for selecting, from the first resource configuration and the second resource configuration, a sidelink channel resource configuration for receiving a data transmission from the second UE. The data transmission component 835 may be configured as or otherwise support a means for receiving the data transmission from the second UE according to the selected sidelink channel resource configuration.

Additionally or alternatively, the communications manager 820 may support wireless communication at a first UE in accordance with examples as disclosed herein. The resource configuration component 825 may be configured as or otherwise support a means for receiving, from a base station, signaling indicating a set of possible resource configurations for a set of symbols for sidelink communications between the first UE and a second UE, each possible resource configuration including two or more TTIs spanning the set of symbols. The indication receiving component 840 may be configured as or otherwise support a means for receiving, from the second UE, an indication of one or more TTI lengths indicating a sidelink channel resource configuration from the set of possible resource configurations. The communication component 845 may be configured as or otherwise support a means for communicating with the second UE according to the sidelink channel resource configuration.

Additionally or alternatively, the communications manager 820 may support wireless communication at a first UE in accordance with examples as disclosed herein. The resource configuration component 825 may be configured as or otherwise support a means for receiving, from a base station, signaling indicating a set of possible resource configurations for a set of symbols for sidelink communications between the first UE and a second UE, each possible resource configuration including two or more TTIs spanning the set of symbols. The indication transmitting component 850 may be configured as or otherwise support a means for transmitting, to the second UE, an indication of one or more TTI lengths indicating a sidelink channel resource configuration from the set of possible resource configurations. The communication component 845 may be configured as or otherwise support a means for communicating with the second UE according to the sidelink channel resource configuration.

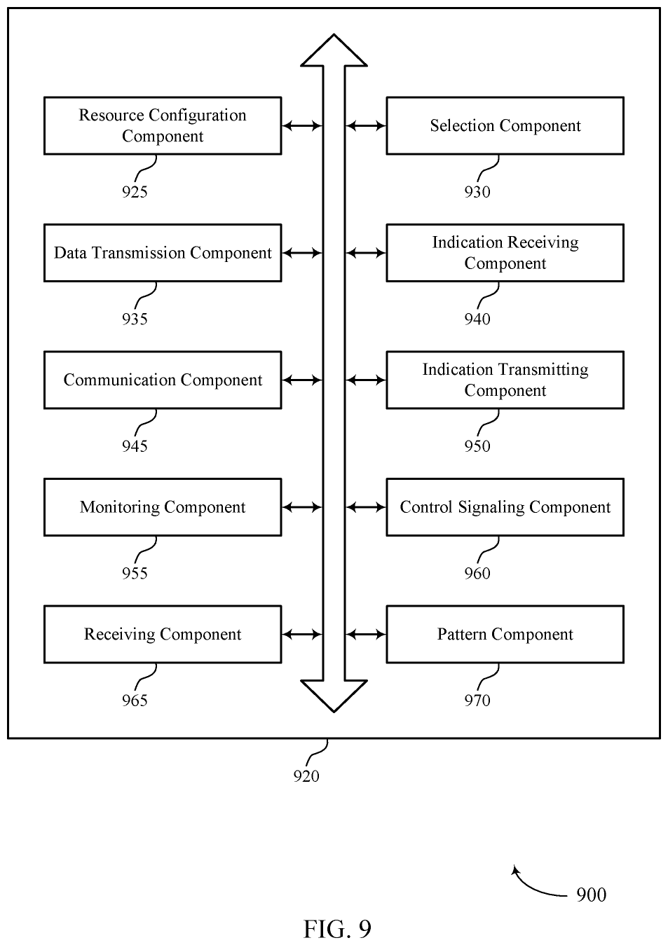

FIG. 9 shows a block diagram 900 of a communications manager 920 that supports slot and subslot-based sidelink communication in accordance with one or more aspects of the present disclosure. The communications manager 920 may be an example of aspects of a communications manager 720, a communications manager 820, or both, as described herein. The communications manager 920, or various components thereof, may be an example of means for performing various aspects of slot and subslot-based sidelink communication as described herein. For example, the communications manager 920 may include a resource configuration component 925, a selection component 930, a data transmission component 935, an indication receiving component 940, a communication component 945, an indication transmitting component 950, a monitoring component 955, a control signaling component 960, a receiving component 965, a pattern component 970, or any combination thereof. Each of these components may communicate, directly or indirectly, with one another (e.g., via one or more buses).

The communications manager 920 may support wireless communication at a first UE in accordance with examples as disclosed herein. The resource configuration component 925 may be configured as or otherwise support a means for determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The selection component 930 may be configured as or otherwise support a means for selecting, from the first resource configuration and the second resource configuration, a sidelink channel resource configuration for a data transmission to the second UE. The data transmission component 935 may be configured as or otherwise support a means for transmitting the data transmission to the second UE according to the selected sidelink channel resource configuration.

In some examples, the monitoring component 955 may be configured as or otherwise support a means for monitoring, during a first symbol of the set of symbols, for a reservation signal received from a third UE for one or more symbols within the set of symbols, where selecting the sidelink channel resource configuration is based on the monitoring.

In some examples, the monitoring component 955 may be configured as or otherwise support a means for detecting the reservation signal from the third UE during the first symbol of the set of symbols, the reservation signal indicating a second data transmission within a second symbol of the set of symbols transmitted from the third UE to the second UE according to the first resource configuration, where selecting the sidelink channel resource configuration includes selecting the first resource configuration based on detecting the reservation signal from the third UE.

In some examples, the monitoring component 955 may be configured as or otherwise support a means for failing to detect the reservation signal from the third UE during the first symbol of the set of symbols based on the monitoring, where selecting the sidelink channel resource configuration includes selecting the second resource configuration based on failing to detect the reservation signal from the third UE.

In some examples, the resource configuration component 925 may be configured as or otherwise support a means for receiving, from a base station, control signaling indicating the first resource configuration or the second resource configuration for the set of symbols, where selecting the sidelink channel resource configuration includes selecting the indicated first resource configuration or the second resource configuration.

In some examples, the resource configuration component 925 may be configured as or otherwise support a means for receiving, from a base station, control signaling indicating the first resource configuration and the second resource configuration for the set of symbols.

In some examples, the selection component 930 may be configured as or otherwise support a means for determining one or more parameters associated with the data transmission, where selecting the sidelink channel resource configuration is based on the one or more parameters.

In some examples, the one or more parameters include a priority associated with the data transmission, a channel busy ratio associated with the sidelink communications, a geographic location of the first UE, a type of the data transmission, or a combination thereof.

In some examples, the control signaling component 960 may be configured as or otherwise support a means for determining, based on one or more parameters associated with the sidelink communications, to transmit a first message or a second message based on a priority of the first message and the second transmission, a length of the first message and the second transmission, or a combination thereof.

In some examples, the one or more parameters associated with the sidelink communications include a first set of resources associated with the feedback message at least partially overlapping with a second set of resources associated with the data transmission, a power scaling procedure for the sidelink communications performed by the first UE, the first UE receiving a reservation signal from a third UE, or a combination thereof.

In some examples, the two or more second TTIs include a first second TTI spanning a first quantity of the set of symbols and a second second TTI spanning a second quantity of the set of symbols different than the first quantity.

In some examples, the single first TTI and each of the two or more second TTIs each include a first symbol associated with AGC, one or more second symbols associated with a PSCCH, one or more third symbols associated with a PSSCH, a fourth symbol associated with a gap symbol, or a combination thereof.

Additionally or alternatively, the communications manager 920 may support wireless communication at a first UE in accordance with examples as disclosed herein. In some examples, the resource configuration component 925 may be configured as or otherwise support a means for determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. In some examples, the selection component 930 may be configured as or otherwise support a means for selecting, from the first resource configuration and the second resource configuration, a sidelink channel resource configuration for receiving a data transmission from the second UE. In some examples, the data transmission component 935 may be configured as or otherwise support a means for receiving the data transmission from the second UE according to the selected sidelink channel resource configuration.

In some examples, the monitoring component 955 may be configured as or otherwise support a means for monitoring, during a first symbol of the set of symbols, for a reservation signal received from a third UE for one or more symbols within the set of symbols, where selecting the sidelink channel resource configuration is based on the monitoring.

In some examples, the receiving component 965 may be configured as or otherwise support a means for receiving, from a base station, control signaling indicating the first resource configuration or the second resource configuration for the set of symbols, where selecting the sidelink channel resource configuration includes selecting the indicated first resource configuration or the second resource configuration.

Additionally or alternatively, the communications manager 920 may support wireless communication at a first UE in accordance with examples as disclosed herein. In some examples, the resource configuration component 925 may be configured as or otherwise support a means for receiving, from a base station, signaling indicating a set of possible resource configurations for a set of symbols for sidelink communications between the first UE and a second UE, each possible resource configuration including two or more TTIs spanning the set of symbols. The indication receiving component 940 may be configured as or otherwise support a means for receiving, from the second UE, an indication of one or more TTI lengths indicating a sidelink channel resource configuration from the set of possible resource configurations. The communication component 945 may be configured as or otherwise support a means for communicating with the second UE according to the sidelink channel resource configuration.

In some examples, the pattern component 970 may be configured as or otherwise support a means for receiving, from the second UE, a second indication of a pattern of TTIs within the set of symbols, where a combination of the indication of one or more TTI lengths and the pattern of TTIs indicates the sidelink channel resource configuration.

In some examples, to support communicating with the second UE, the communication component 945 may be configured as or otherwise support a means for monitoring a first TTI of the two or more TTIs. In some examples, to support communicating with the second UE, the communication component 945 may be configured as or otherwise support a means for transmitting, based on the monitoring, a feedback message within a second TTI of the two or more TTIs indicating whether communications from the second UE are received in the first TTI.

In some examples, the sidelink channel resource configuration is for communications between the first UE and the second UE via a first component carrier, the method further including. In some examples the resource configuration component 925 may be configured as or otherwise support a means for receiving, from the second UE, a second indication of one or more TTI lengths indicating a second sidelink channel resource configuration from the set of possible resource configurations for communications between the first UE and the second UE via a second component carrier, the second sidelink channel resource configuration different from the sidelink channel resource configuration for communications via the first component carrier and the resource configuration component 925 may be configured as or otherwise support a means for communicating with the second UE via the second component carrier according to the second sidelink channel resource configuration.

In some examples, the resource configuration component 925 may be configured as or otherwise support a means for monitoring the first component carrier during a first TTI of the two or more TTIs. In some examples, the resource configuration component 925 may be configured as or otherwise support a means for monitoring the second component carrier during a second TTI of the two or more TTIs. In some examples, the resource configuration component 925 may be configured as or otherwise support a means for transmitting, based on monitoring the first component carrier and the second component carrier, a feedback message indicating whether communications from the second UE are received via the first component carrier and the second component carrier.

In some examples, the resource configuration component 925 may be configured as or otherwise support a means for monitoring the first component carrier during a first TTI of the two or more TTIs. In some examples, the resource configuration component 925 may be configured as or otherwise support a means for monitoring the second component carrier during a second TTI of the two or more TTIs. In some examples, the resource configuration component 925 may be configured as or otherwise support a means for transmitting, based on monitoring the first component carrier, a first feedback message indicating whether communications from the second UE are received via the first component carrier. In some examples, the resource configuration component 925 may be configured as or otherwise support a means for transmitting, based on monitoring the second component carrier, a second feedback message indicating whether communications from the second UE are received via the second component carrier.

In some examples, to support communicating with the second UE, the communication component 945 may be configured as or otherwise support a means for transmitting a signal, during a first TTI of the two or more TTIs, reserving one or more symbols for communicating with the second UE in the first TTI. In some examples, to support communicating with the second UE, the communication component 945 may be configured as or otherwise support a means for communicating with the second UE in the reserved one or more symbols in the first TTI.

In some examples, the signal indicates a periodicity for communicating with the second UE in the reserved one or more symbols of the first TTI. In some examples, communicating with the second UE further includes communicating with the second UE in the reserved one or more symbols of the first TTI within two or more additional sets of symbols in accordance with the indicated periodicity.

In some examples, to support communicating with the second UE, the communication component 945 may be configured as or otherwise support a means for transmitting a signal, during a first TTI of the two or more TTIs, reserving one or more symbols for communicating with the second UE in a second TTI of the two or more TTIs. In some examples, to support communicating with the second UE, the communication component 945 may be configured as or otherwise support a means for communicating with the second UE in the reserved one or more symbols in the second TTI.

In some examples, the signal indicates a periodicity for communicating with the second UE in the reserved one or more symbols of the second TTI. In some examples, communicating with the second UE further includes communicating with the second UE in the reserved one or more symbols of the second TTI within two or more additional sets of symbols in accordance with the indicated periodicity.

In some examples, at least one of the possible resource configurations includes two TTIs each spanning one or more of the set of symbols and configured for physical sidelink feedback channel communications between the first UE and the second UE.

In some examples, each possible resource configuration indicates a subchannel size, a quantity of subchannels, a feedback configuration, a reference signal configuration, a duration of a physical sidelink control channel, or a combination thereof.

In some examples, to support receiving signaling, the resource configuration component 925 may be configured as or otherwise support a means for receiving radio resource control signaling from the base station.

Additionally or alternatively, the communications manager 920 may support wireless communication at a first UE in accordance with examples as disclosed herein. In some examples, the resource configuration component 925 may be configured as or otherwise support a means for receiving, from a base station, signaling indicating a set of possible resource configurations for a set of symbols for sidelink communications between the first UE and a second UE, each possible resource configuration including two or more TTIs spanning the set of symbols. The indication transmitting component 950 may be configured as or otherwise support a means for transmitting, to the second UE, an indication of one or more TTI lengths indicating a sidelink channel resource configuration from the set of possible resource configurations. In some examples, the communication component 945 may be configured as or otherwise support a means for communicating with the second UE according to the sidelink channel resource configuration.

In some examples, the pattern component 970 may be configured as or otherwise support a means for transmitting, to the second UE, a second indication of a pattern of TTIs within the set of symbols, where a combination of the indication of one or more TTI lengths and the pattern of TTIs indicates the sidelink channel resource configuration.

In some examples, to support communicating with the second UE, the communication component 945 may be configured as or otherwise support a means for transmitting, to the second UE, a message within a first TTI of the two or more TTIs. In some examples, to support communicating with the second UE, the communication component 945 may be configured as or otherwise support a means for receiving, based on the monitoring, a feedback message within a second TTI of the two or more TTIs indicating whether the second UE received the message within the first TTI.

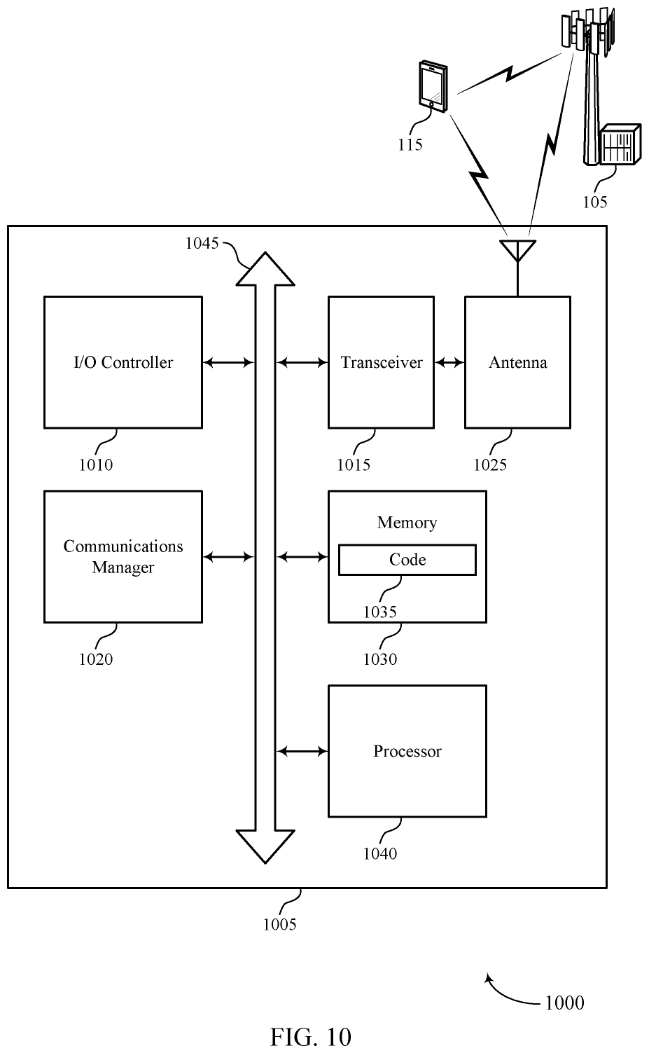

FIG. 10 shows a diagram of a system 1000 including a device 1005 that supports slot and subslot-based sidelink communication in accordance with one or more aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting slot and subslot-based sidelink communication). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at a first UE in accordance with examples as disclosed herein. For example, the communications manager 1020 may be configured as or otherwise support a means for determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The communications manager 1020 may be configured as or otherwise support a means for selecting, from the first resource configuration and the second resource configuration, a sidelink channel resource configuration for a data transmission to the second UE. The communications manager 1020 may be configured as or otherwise support a means for transmitting the data transmission to the second UE according to the selected sidelink channel resource configuration.

Additionally or alternatively, the communications manager 1020 may support wireless communication at a first UE in accordance with examples as disclosed herein. For example, the communications manager 1020 may be configured as or otherwise support a means for determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The communications manager 1020 may be configured as or otherwise support a means for selecting, from the first resource configuration and the second resource configuration, a sidelink channel resource configuration for receiving a data transmission from the second UE. The communications manager 1020 may be configured as or otherwise support a means for receiving the data transmission from the second UE according to the selected sidelink channel resource configuration.

Additionally or alternatively, the communications manager 1020 may support wireless communication at a first UE in accordance with examples as disclosed herein. For example, the communications manager 1020 may be configured as or otherwise support a means for receiving, from a base station, signaling indicating a set of possible resource configurations for a set of symbols for sidelink communications between the first UE and a second UE, each possible resource configuration including two or more TTIs spanning the set of symbols. The communications manager 1020 may be configured as or otherwise support a means for receiving, from the second UE, an indication of one or more TTI lengths indicating a sidelink channel resource configuration from the set of possible resource configurations. The communications manager 1020 may be configured as or otherwise support a means for communicating with the second UE according to the sidelink channel resource configuration.

Additionally or alternatively, the communications manager 1020 may support wireless communication at a first UE in accordance with examples as disclosed herein. For example, the communications manager 1020 may be configured as or otherwise support a means for receiving, from a base station, signaling indicating a set of possible resource configurations for a set of symbols for sidelink communications between the first UE and a second UE, each possible resource configuration including two or more TTIs spanning the set of symbols. The communications manager 1020 may be configured as or otherwise support a means for transmitting, to the second UE, an indication of one or more TTI lengths indicating a sidelink channel resource configuration from the set of possible resource configurations. The communications manager 1020 may be configured as or otherwise support a means for communicating with the second UE according to the sidelink channel resource configuration.

By including or configuring the communications manager 1020 in accordance with examples as described herein, the device 1005 may support techniques for slot and subslot-based sidelink communication which may improve reliability and resource efficiency, and decrease latency. As such, supported techniques may include improved network operations and, in some examples, may promote network efficiencies, among other aspects.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of slot and subslot-based sidelink communication as described herein, or the processor 1040 and the memory 1030 may be otherwise configured to perform or support such operations.

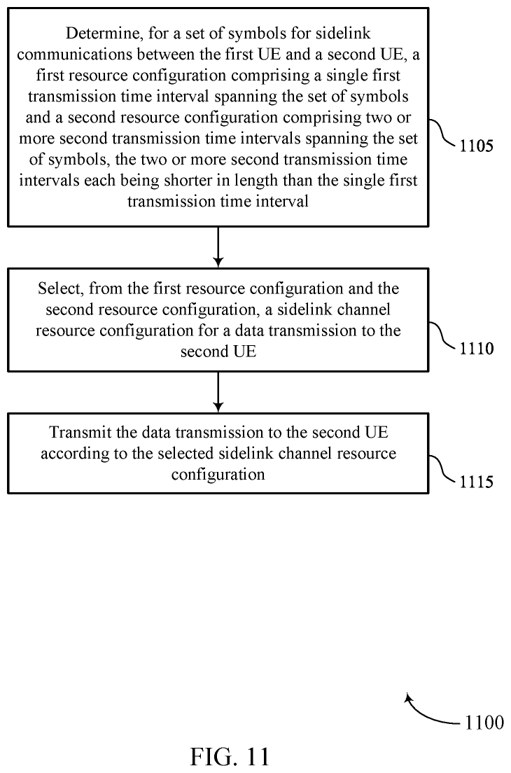

FIG. 11 shows a flowchart illustrating a method 1100 that supports slot and subslot-based sidelink communication in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1105, the method may include determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The operations of 1105 may be performed in accordance with examples as disclosed herein. In some examples, aspects of the operations of 1105 may be performed by a resource configuration component 925 as described with reference to FIG. 9.

At 1110, the method may include selecting, from the first resource configuration and the second resource configuration, a sidelink channel resource configuration for a data transmission to the second UE. The operations of 1110 may be performed in accordance with examples as disclosed herein. In some examples, aspects of the operations of 1110 may be performed by a selection component 930 as described with reference to FIG. 9.

At 1115, the method may include transmitting the data transmission to the second UE according to the selected sidelink channel resource configuration. The operations of 1115 may be performed in accordance with examples as disclosed herein. In some examples, aspects of the operations of 1115 may be performed by a data transmission component 935 as described with reference to FIG. 9.

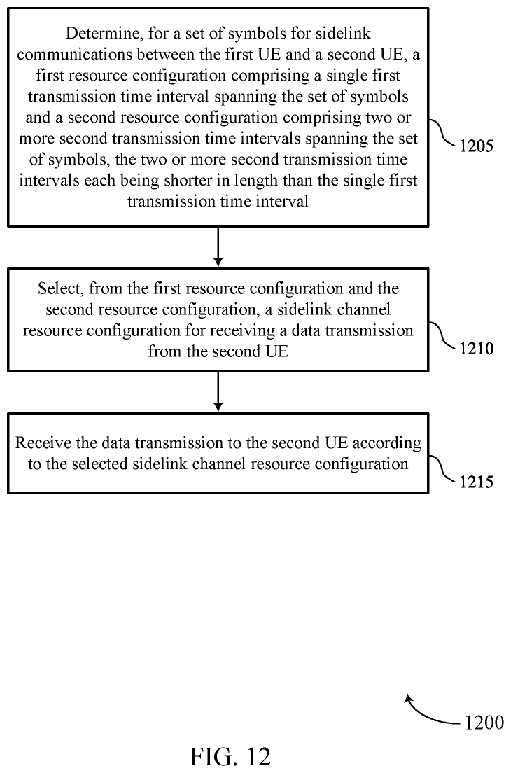

FIG. 12 shows a flowchart illustrating a method 1200 that supports slot and subslot-based sidelink communication in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1205, the method may include determining, for a set of symbols for sidelink communications between the first UE and a second UE, a first resource configuration including a single first TTI spanning the set of symbols and a second resource configuration including two or more second TTIs spanning the set of symbols, the two or more second TTIs each being shorter in length than the single first TTI. The operations of 1205 may be performed in accordance with examples as disclosed herein. In some examples, aspects of the operations of 1205 may be performed by a resource configuration component 925 as described with reference to FIG. 9.

At 1210, the method may include selecting, from the first resource configuration and the second resource configuration, a sidelink channel resource configuration for receiving a data transmission from the second UE. The operations of 1210 may be performed in accordance with examples as disclosed herein. In some examples, aspects of the operations of 1210 may be performed by a selection component 930 as described with reference to FIG. 9.

At 1215, the method may include receiving the data transmission from the second UE according to the selected sidelink channel resource configuration. The operations of 1215 may be performed in accordance with examples as disclosed herein. In some examples, aspects of the operations of 1215 may be performed by a data transmission component 935 as described with reference to FIG. 9.

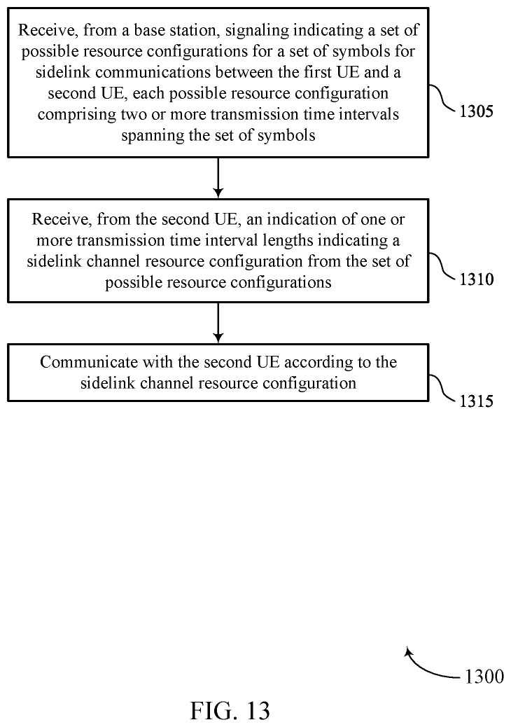

FIG. 13 shows a flowchart illustrating a method 1300 that supports slot and subslot-based sidelink communication in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, signaling indicating a set of possible resource configurations for a set of symbols for sidelink communications between the first UE and a second UE, each possible resource configuration including two or more TTIs spanning the set of symbols. The operations of 1305 may be performed in accordance with examples as disclosed herein. In some examples, aspects of the operations of 1305 may be performed by a resource configuration component 925 as described with reference to FIG. 9.

At 1310, the method may include receiving, from the second UE, an indication of one or more TTI lengths indicating a sidelink channel resource configuration from the set of possible resource configurations. The operations of 1310 may be performed in accordance with examples as disclosed herein. In some examples, aspects of the operations of 1310 may be performed by an indication receiving component 940 as described with reference to FIG. 9.

At 1315, the method may include communicating with the second UE according to the sidelink channel resource configuration. The operations of 1315 may be performed in accordance with examples as disclosed herein. In some examples, aspects of the operations of 1315 may be performed by a communication component 945 as described with reference to FIG. 9.

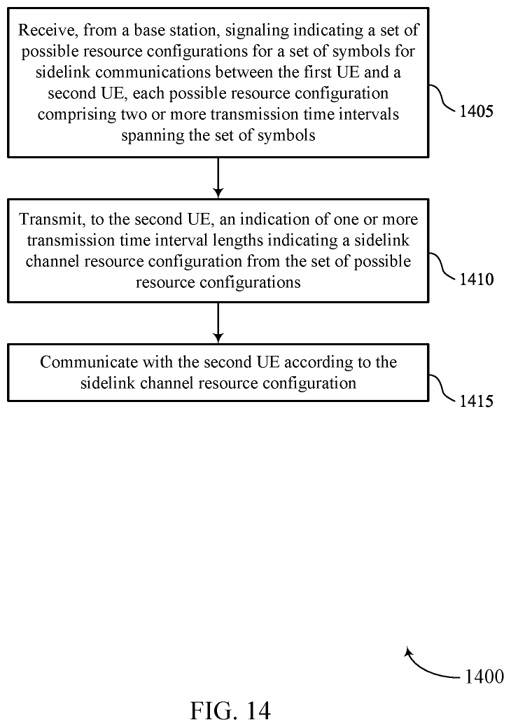

FIG. 14 shows a flowchart illustrating a method 1400 that supports slot and subslot-based sidelink communication in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, signaling indicating a set of possible resource configurations for a set of symbols for sidelink communications between the first UE and a second UE, each possible resource configuration including two or more TTIs spanning the set of symbols. The operations of 1405 may be performed in accordance with examples as disclosed herein. In some examples, aspects of the operations of 1405 may be performed by a resource configuration component 925 as described with reference to FIG. 9.

At 1410, the method may include transmitting, to the second UE, an indication of one or more TTI lengths indicating a sidelink channel resource configuration from the set of possible resource configurations. The operations of 1410 may be performed in accordance with examples as disclosed herein. In some examples, aspects of the operations of 1410 may be performed by an indication transmitting component 950 as described with reference to FIG. 9.

At 1415, the method may include communicating with the second UE according to the sidelink channel resource configuration. The operations of 1415 may be performed in accordance with examples as disclosed herein. In some examples, aspects of the operations of 1415 may be performed by a communication component 945 as described with reference to FIG. 9.

The following provides an overview of aspects of the present disclosure:

Aspect 1: A method for wireless communication at a first UE, comprising: determining, for a set of symbols for sidelink communications between the first UE and a second UE, a first resource configuration comprising a single first TTI spanning the set of symbols and a second resource configuration comprising two or more second TTIs spanning the set of symbols, the two or more second TTIs each being shorter in length than the single first TTI; selecting, from the first resource configuration and the second resource configuration, a sidelink channel resource configuration for a data transmission to the second UE; and transmitting the data transmission to the second UE according to the selected sidelink channel resource configuration.

Aspect 2: The method of aspect 1, further comprising: monitoring, during a first symbol of the set of symbols, for a reservation signal received from a third UE for one or more symbols within the set of symbols, wherein selecting the sidelink channel resource configuration is based at least in part on the monitoring.

Aspect 3: The method of aspect 2, further comprising: detecting the reservation signal from the third UE during the first symbol of the set of symbols, the reservation signal indicating a second data transmission within a second symbol of the set of symbols transmitted from the third UE to the second UE according to the first resource configuration, wherein selecting the sidelink channel resource configuration comprises selecting the first resource configuration based at least in part on detecting the reservation signal from the third UE.

Aspect 4: The method of any of aspects 2 through 3, further comprising: failing to detect the reservation signal from the third UE during the first symbol of the set of symbols based at least in part on the monitoring, wherein selecting the sidelink channel resource configuration comprises selecting the second resource configuration based at least in part on failing to detect the reservation signal from the third UE.

Aspect 5: The method of any of aspects 1 through 4, further comprising: receiving, from a base station, control signaling indicating the first resource configuration or the second resource configuration for the set of symbols, wherein selecting the sidelink channel resource configuration comprises selecting the indicated first resource configuration or the second resource configuration.

Aspect 6: The method of any of aspects 1 through 5, further comprising: receiving, from a base station, control signaling indicating the first resource configuration and the second resource configuration for the set of symbols.

Aspect 7: The method of any of aspects 1 through 6, further comprising: determining one or more parameters associated with the data transmission, wherein selecting the sidelink channel resource configuration is based at least in part on the one or more parameters.

Aspect 8: The method of aspect 7, wherein the one or more parameters comprise a priority associated with the data transmission, a channel busy ratio associated with the sidelink communications, a geographic location of the first UE, a type of the data transmission, or a combination thereof.

Aspect 9: The method of any of aspects 1 through 8, further comprising: determining, based on one or more parameters associated with the sidelink communications, to transmit a first message or a second message based on a priority of the first message and the second transmission, a length of the first message and the second transmission, or a combination thereof.

Aspect 10: The method of aspect 9, wherein the one or more parameters associated with the sidelink communications comprise a first set of resources associated with the feedback message at least partially overlapping with a second set of resources associated with the data transmission, a power scaling procedure for the sidelink communications performed by the first UE, the first UE receiving a reservation signal from a third UE, or a combination thereof.

Aspect 11: The method of any of aspects 1 through 10, wherein the two or more second TTIs comprise a first second TTI spanning a first quantity of the set of symbols and a second second TTI spanning a second quantity of the set of symbols different than the first quantity.

Aspect 12: The method of any of aspects 1 through 11, wherein the single first TTI and each of the two or more second TTIs each comprise a first symbol associated with AGC, one or more second symbols associated with a PSCCH, one or more third symbols associated with a PSSCH, a fourth symbol associated with a gap symbol, or a combination thereof.

Aspect 13: A method for wireless communication at a first UE, comprising: determining, for a set of symbols for sidelink communications between the first UE and a second UE, a first resource configuration comprising a single first TTI spanning the set of symbols and a second resource configuration comprising two or more second TTIs spanning the set of symbols, the two or more second TTIs each being shorter in length than the single first TTI; selecting, from the first resource configuration and the second resource configuration, a sidelink channel resource configuration for receiving a data transmission from the second UE; and receiving the data transmission from the second UE according to the selected sidelink channel resource configuration.

Aspect 14: The method of aspect 13, further comprising: monitoring, during a first symbol of the set of symbols, for a reservation signal received from a third UE for one or more symbols within the set of symbols, wherein selecting the sidelink channel resource configuration is based at least in part on the monitoring.

Aspect 15: The method of any of aspects 13 through 14, further comprising: receiving, from a base station, control signaling indicating the first resource configuration or the second resource configuration for the set of symbols, wherein selecting the sidelink channel resource configuration comprises selecting the indicated first resource configuration or the second resource configuration.

Aspect 16: A method for wireless communication at a first UE, comprising: receiving, from a base station, signaling indicating a set of possible resource configurations for a set of symbols for sidelink communications between the first UE and a second UE, each possible resource configuration comprising two or more TTIs spanning the set of symbols; receiving, from the second UE, an indication of one or more TTI lengths indicating a sidelink channel resource configuration from the set of possible resource configurations; and communicating with the second UE according to the sidelink channel resource configuration.

Aspect 17: The method of aspect 16, further comprising: receiving, from the second UE, a second indication of a pattern of TTIs within the set of symbols, wherein a combination of the indication of one or more TTI lengths and the pattern of TTIs indicates the sidelink channel resource configuration.

Aspect 18: The method of any of aspects 16 through 17, wherein communicating with the second UE comprises: monitoring a first TTI of the two or more TTIs; and transmitting, based at least in part on the monitoring, a feedback message within a second TTI of the two or more TTIs indicating whether communications from the second UE are received in the first TTI.

Aspect 19: The method of any of aspects 16 through 18, wherein the sidelink channel resource configuration is for communications between the first UE and the second UE via a first component carrier, the method further comprising: receiving, from the second UE, a second indication of one or more TTI lengths indicating a second sidelink channel resource configuration from the set of possible resource configurations for communications between the first UE and the second UE via a second component carrier, the second sidelink channel resource configuration different from the sidelink channel resource configuration for communications via the first component carrier; and communicating with the second UE via the second component carrier according to the second sidelink channel resource configuration.

Aspect 20: The method of aspect 19, further comprising: monitoring the first component carrier during a first TTI of the two or more TTIs; monitoring the second component carrier during a second TTI of the two or more TTIs; and transmitting, based at least in part on monitoring the first component carrier and the second component carrier, a feedback message indicating whether communications from the second UE are received via the first component carrier and the second component carrier.

Aspect 21: The method of any of aspects 19 through 20, further comprising: monitoring the first component carrier during a first TTI of the two or more TTIs; monitoring the second component carrier during a second TTI of the two or more TTIs; transmitting, based at least in part on monitoring the first component carrier, a first feedback message indicating whether communications from the second UE are received via the first component carrier; and transmitting, based at least in part on monitoring the second component carrier, a second feedback message indicating whether communications from the second UE are received via the second component carrier.

Aspect 22: The method of any of aspects 16 through 21, wherein communicating with the second UE comprises: transmitting a signal, during a first TTI of the two or more TTIs, reserving one or more symbols for communicating with the second UE in the first TTI; and communicating with the second UE in the reserved one or more symbols in the first TTI.

Aspect 23: The method of aspect 22, wherein the signal indicates a periodicity for communicating with the second UE in the reserved one or more symbols of the first TTI; and communicating with the second UE further comprises communicating with the second UE in the reserved one or more symbols of the first TTI within two or more additional sets of symbols in accordance with the indicated periodicity.

Aspect 24: The method of any of aspects 16 through 23, wherein communicating with the second UE comprises: transmitting a signal, during a first TTI of the two or more TTIs, reserving one or more symbols for communicating with the second UE in a second TTI of the two or more TTIs; and communicating with the second UE in the reserved one or more symbols in the second TTI.

Aspect 25: The method of aspect 24, wherein the signal indicates a periodicity for communicating with the second UE in the reserved one or more symbols of the second TTI; and communicating with the second UE further comprises communicating with the second UE in the reserved one or more symbols of the second TTI within two or more additional sets of symbols in accordance with the indicated periodicity.

Aspect 26: The method of any of aspects 16 through 25, wherein at least one of the possible resource configurations comprises two TTIs each spanning one or more of the set of symbols and configured for physical sidelink feedback channel communications between the first UE and the second UE.

Aspect 27: The method of any of aspects 16 through 26, wherein each possible resource configuration indicates a subchannel size, a quantity of subchannels, a feedback configuration, a reference signal configuration, a duration of a physical sidelink control channel, or a combination thereof.

Aspect 28: The method of any of aspects 16 through 27, wherein receiving signaling comprises: receiving radio resource control signaling from the base station.

Aspect 29: A method for wireless communication at a first UE, comprising: receiving, from a base station, signaling indicating a set of possible resource configurations for a set of symbols for sidelink communications between the first UE and a second UE, each possible resource configuration comprising two or more TTIs spanning the set of symbols; transmitting, to the second UE, an indication of one or more TTI lengths indicating a sidelink channel resource configuration from the set of possible resource configurations; and communicating with the second UE according to the sidelink channel resource configuration.

Aspect 30: The method of aspect 29, further comprising: transmitting, to the second UE, a second indication of a pattern of TTIs within the set of symbols, wherein a combination of the indication of one or more TTI lengths and the pattern of TTIs indicates the sidelink channel resource configuration.

Aspect 31: The method of any of aspects 29 through 30, wherein communicating with the second UE comprises: transmitting, to the second UE, a message within a first TTI of the two or more TTIs; and receiving, based at least in part on the monitoring, a feedback message within a second TTI of the two or more TTIs indicating whether the second UE received the message within the first TTI.

Aspect 32: An apparatus for wireless communication at a first UE, comprising a processor and memory coupled with the processor; the processor and memory configured to cause the apparatus to perform a method of any of aspects 1 through 11.

Aspect 33: An apparatus for wireless communication at a first UE, comprising at least one means for performing a method of any of aspects 1 through 11.

Aspect 34: A non-transitory computer-readable medium storing code for wireless communication at a first UE, the code comprising instructions executable by a processor to perform a method of any of aspects 1 through 11.

Aspect 35: An apparatus for wireless communication at a first UE, comprising a processor; memory coupled with the processor; and the processor and memory configured to cause the apparatus to perform a method of any of aspects 13 through 15.

Aspect 36: An apparatus for wireless communication at a first UE, comprising at least one means for performing a method of any of aspects 13 through 15.

Aspect 37: A non-transitory computer-readable medium storing code for wireless communication at a first UE, the code comprising instructions executable by a processor to perform a method of any of aspects 13 through 15.

Aspect 38: An apparatus for wireless communication at a first UE, comprising a processor; memory coupled with the processor; and the processor and memory configured to cause the apparatus to perform a method of any of aspects 16 through 28.

Aspect 39: An apparatus for wireless communication at a first UE, comprising at least one means for performing a method of any of aspects 16 through 28.

Aspect 40: A non-transitory computer-readable medium storing code for wireless communication at a first UE, the code comprising instructions executable by a processor to perform a method of any of aspects 16 through 28.

Aspect 41: An apparatus for wireless communication at a first UE, comprising a processor; memory coupled with the processor; and processor and memory configured to cause the apparatus to perform a method of any of aspects 29 through 31.

Aspect 42: An apparatus for wireless communication at a first UE, comprising at least one means for performing a method of any of aspects 29 through 31.

Aspect 43: A non-transitory computer-readable medium storing code for wireless communication at a first UE, the code comprising instructions executable by a processor to perform a method of any of aspects 29 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
determining, for a set of symbols for sidelink communications between the first UE and a second UE, a first resource configuration comprising a single first transmission time interval spanning the set of symbols and a second resource configuration comprising two or more second transmission time intervals spanning the set of symbols, the two or more second transmission time intervals each being shorter in length than the single first transmission time interval;
selecting, from the first resource configuration and the second resource configuration, a sidelink channel resource configuration for a data transmission to the second UE; and
transmitting the data transmission to the second UE according to the selected sidelink channel resource configuration.

2. The method of claim 1, further comprising:
monitoring, during a first symbol of the set of symbols, for a reservation signal received from a third UE for one or more symbols within the set of symbols, wherein selecting the sidelink channel resource configuration is based at least in part on the monitoring.

3. The method of claim 2, further comprising:
detecting the reservation signal from the third UE during the first symbol of the set of symbols, the reservation signal indicating a second data transmission within a second symbol of the set of symbols transmitted from the third UE to the second UE according to the first resource configuration, wherein selecting the sidelink channel resource configuration comprises selecting the first resource configuration based at least in part on detecting the reservation signal from the third UE.

4. The method of claim 2, further comprising:
failing to detect the reservation signal from the third UE during the first symbol of the set of symbols based at least in part on the monitoring, wherein selecting the sidelink channel resource configuration comprises selecting the second resource configuration based at least in part on failing to detect the reservation signal from the third UE.

5. The method of claim 1, further comprising:
receiving, from a base station, control signaling indicating the first resource configuration or the second resource configuration for the set of symbols, wherein selecting the sidelink channel resource configuration comprises selecting the indicated first resource configuration or the second resource configuration.

6. The method of claim 1, further comprising:
receiving, from a base station, control signaling indicating the first resource configuration and the second resource configuration for the set of symbols.

7. The method of claim 1, further comprising:
determining one or more parameters associated with the data transmission, wherein selecting the sidelink channel resource configuration is based at least in part on the one or more parameters.

8. The method of claim 7, wherein the one or more parameters comprise a priority associated with the data transmission, a channel busy ratio associated with the sidelink communications, a geographic location of the first UE, a type of the data transmission, or a combination thereof.

9. The method of claim 1, further comprising:
determining, based at least in part on one or more parameters associated with the sidelink communications, to transmit a first message or a second message based at least in part on a priority of the first message and the second transmission, a length of the first message and the second transmission, or a combination thereof.

10. The method of claim 9, wherein the one or more parameters associated with the sidelink communications comprise a first set of resources associated with the first message at least partially overlapping with a second set of resources associated with the second message, a power scaling procedure for the sidelink communications performed by the first UE, the first UE receiving a reservation signal from a third UE, or a combination thereof.

11. The method of claim 1, wherein the two or more second transmission time intervals comprise a first second transmission time interval spanning a first quantity of the set of symbols and a second second transmission time interval spanning a second quantity of the set of symbols different than the first quantity.

12. The method of claim 1, wherein the single first transmission time interval and each of the two or more second transmission time intervals each comprise a first symbol associated with automatic gain control, one or more second symbols associated with a physical sidelink control channel, one or more third symbols associated with a physical sidelink data channel, a fourth symbol associated with a gap symbol, or a combination thereof.

13. A method for wireless communication at a first user equipment (UE), comprising:
determining, for a set of symbols for sidelink communications between the first UE and a second UE, a first resource configuration comprising a single first transmission time interval spanning the set of symbols and a second resource configuration comprising two or more second transmission time intervals spanning the set of symbols, the two or more second transmission time intervals each being shorter in length than the single first transmission time interval;
selecting, from the first resource configuration and the second resource configuration, a sidelink channel resource configuration for receiving a data transmission from the second UE; and
receiving the data transmission from the second UE according to the selected sidelink channel resource configuration.

14. The method of claim 13, further comprising:
monitoring, during a first symbol of the set of symbols, for a reservation signal received from a third UE for one or more symbols within the set of symbols, wherein selecting the sidelink channel resource configuration is based at least in part on the monitoring.

15. The method of claim 13, further comprising:
receiving, from a base station, control signaling indicating the first resource configuration or the second resource configuration for the set of symbols, wherein selecting the sidelink channel resource configuration comprises selecting the indicated first resource configuration or the second resource configuration.

16. A method for wireless communication at a first user equipment (UE), comprising:
receiving, from a base station, signaling indicating a set of possible resource configurations for a set of symbols for sidelink communications between the first UE and a second UE, each possible resource configuration comprising two or more transmission time intervals spanning the set of symbols;
receiving, from the second UE, an indication of one or more transmission time interval lengths indicating a sidelink channel resource configuration from the set of possible resource configurations; and
communicating with the second UE according to the sidelink channel resource configuration.

17. The method of claim 16, further comprising:
receiving, from the second UE, a second indication of a pattern of transmission time intervals within the set of symbols, wherein a combination of the indication of one or more transmission time interval lengths and the pattern of transmission time intervals indicates the sidelink channel resource configuration.

18. The method of claim 16, wherein communicating with the second UE comprises:
monitoring a first transmission time interval of the two or more transmission time intervals; and
transmitting, based at least in part on the monitoring, a feedback message within a second transmission time interval of the two or more transmission time intervals indicating whether communications from the second UE are received in the first transmission time interval.

19. The method of claim 16, wherein
the sidelink channel resource configuration is for communications between the first UE and the second UE via a first component carrier, the method further comprising:
receiving, from the second UE, a second indication of one or more transmission time interval lengths indicating a second sidelink channel resource configuration from the set of possible resource configurations for communications between the first UE and the second UE via a second component carrier, the second sidelink channel resource configuration different from the sidelink channel resource configuration for communications via the first component carrier; and
communicating with the second UE via the second component carrier according to the second sidelink channel resource configuration.

20. The method of claim 19, further comprising:
monitoring the first component carrier during a first transmission time interval of the two or more transmission time intervals;
monitoring the second component carrier during a second transmission time interval of the two or more transmission time intervals; and
transmitting, based at least in part on monitoring the first component carrier and the second component carrier, a feedback message indicating whether communications from the second UE are received via the first component carrier and the second component carrier.

21. The method of claim 19, further comprising:
monitoring the first component carrier during a first transmission time interval of the two or more transmission time intervals;
monitoring the second component carrier during a second transmission time interval of the two or more transmission time intervals;
transmitting, based at least in part on monitoring the first component carrier, a first feedback message indicating whether communications from the second UE are received via the first component carrier; and
transmitting, based at least in part on monitoring the second component carrier, a second feedback message indicating whether communications from the second UE are received via the second component carrier.

22. The method of claim 16, wherein communicating with the second UE comprises:
transmitting a signal, during a first transmission time interval of the two or more transmission time intervals, reserving one or more symbols for communicating with the second UE in the first transmission time interval; and
communicating with the second UE in the reserved one or more symbols in the first transmission time interval.

23. The method of claim 22, wherein:
the signal indicates a periodicity for communicating with the second UE in the reserved one or more symbols of the first transmission time interval; and
communicating with the second UE further comprises communicating with the second UE in the reserved one or more symbols of the first transmission time interval within two or more additional sets of symbols in accordance with the indicated periodicity.

24. The method of claim 16, wherein communicating with the second UE comprises:
transmitting a signal, during a first transmission time interval of the two or more transmission time intervals, reserving one or more symbols for communicating with the second UE in a second transmission time interval of the two or more transmission time intervals; and
communicating with the second UE in the reserved one or more symbols in the second transmission time interval.

25. The method of claim 24, wherein:
the signal indicates a periodicity for communicating with the second UE in the reserved one or more symbols of the second transmission time interval; and
communicating with the second UE further comprises communicating with the second UE in the reserved one or more symbols of the second transmission time interval within two or more additional sets of symbols in accordance with the indicated periodicity.

26. The method of claim 16, wherein at least one of the possible resource configurations comprises two transmission time intervals each spanning one or more of the set of symbols and configured for physical sidelink feedback channel communications between the first UE and the second UE.

27. The method of claim 16, wherein each possible resource configuration indicates a subchannel size, a quantity of subchannels, a feedback configuration, a reference signal configuration, a duration of a physical sidelink control channel, or a combination thereof.

28. The method of claim 16, wherein receiving signaling comprises:
receiving radio resource control signaling from the base station.

29. A method for wireless communication at a first user equipment (UE), comprising:
receiving, from a base station, signaling indicating a set of possible resource configurations for a set of symbols for sidelink communications between the first UE and a second UE, each possible resource configuration comprising two or more transmission time intervals spanning the set of symbols;
transmitting, to the second UE, an indication of one or more transmission time interval lengths indicating a sidelink channel resource configuration from the set of possible resource configurations; and
communicating with the second UE according to the sidelink channel resource configuration.

30. The method of claim 29, further comprising:
transmitting, to the second UE, a second indication of a pattern of transmission time intervals within the set of symbols, wherein a combination of the indication of one or more transmission time interval lengths and the pattern of transmission time intervals indicates the sidelink channel resource configuration.
